(19) United States
(12) Patent Application Publication
(10) Pub. No.: US 2013/0219307 A1
(43) Pub. Date: Aug. 22, 2013

(54) SYSTEM AND METHOD FOR RUNTIME USER INTERFACE MANAGEMENT

(71) Applicant: Artisan Mobile, Inc., (US)

(72) Inventors: Michael S. Raber, West Chester, PA (US); Daniel E. Koch, Philadelphia, PA (US)

(73) Assignee: Artisan Mobile, Inc., Philadelphia, PA (US)

(21) Appl. No.: 13/773,102

(22) Filed: Feb. 21, 2013

Related U.S. Application Data
(63) Continuation of application No. 61/601,174, filed on Feb. 21, 2012.
(60) Provisional application No. 61/702,531, filed on Sep. 18, 2012.
(60) Provisional application No. 61/705,096, filed on Sep. 24, 2012.

(51) Int. Cl. G06F 3/0484

(52) U.S. Cl. CPC G06F 3/0484
USPC 715/763

(57) ABSTRACT

The system allows for modification of a software application's user interface screen after compilation and/or distribution. Changes to the interface are permitted during runtime of the application, by associating a unique identification code with each user interface control of the screen. The identification code is used outside of the application to reference the controls, and to update associated information for displaying the controls. The updates may be provided as properties associated with specific identification codes contained in the application, e.g., as a playlist document created and/or received after compiling and distribution of the software application to client devices. The application includes a software development kit (SDK) for managing the receipt and application of playlist updates, prior to display of the user interface by the application. The system enables direct display and manipulation of user interface control properties in creating playlists, and manages playlist distribution, e.g., to enable multivariate testing.

### CROSS-REFERENCE TO RELATED APPLICATIONS

This application claims the benefit of priority under 35 U.S.C. §119(e) of U.S. Provisional Patent Applications Nos. 61/601,174, filed Feb. 21, 2012, 61/702,531, filed Sep. 18, 2012, and 61/705,096 filed Sep. 24, 2012, the entire disclosures of each of which are hereby incorporated herein by reference.

### FIELD OF THE INVENTION

The present invention relates generally to development and/or management of graphical user interfaces for software applications of computing devices, and more particularly to a system and method for user interface management at application runtime.

### DISCUSSION OF RELATED ART

Client/server application developers traditionally use tools to build software using an integrated development environment (IDE). Most IDEs require a human programmer/developer to follow a specific and conventional development path. This path involves first writing the application code, then compiling the code, and then sending the compiled code to a client computing device (or device simulator/emulator) so that the resulting software application can be executed/started, and the application's runtime user interface can be viewed by the developer and debugged, modified, etc. Accordingly, the device software will run not on the intended device (e.g., an iPhone), but on the computing device at which the developer is writing the code. For example, and IDS can be used to build a Java application that will run on the developer's computer without the need for a simulator/emulator.

Some IDEs provide tools for designing the user interface in a visual way, but such tools still require the compiling of the code and sending the newly-compiled code to a client computing device (or device simulator/emulator) so that the application can be started, and the user interface can be viewed by the developer and debugged, modified, etc. An example of this approach is Apple's xCode development environment in which the user interface is compiled into the application bundle and the application can be viewed using an iOS simulator or on the intended computing device (e.g., iPhone).

An alternative development approach is to provide a set of tools that emulate a device (e.g., an iPhone in a browser) and use a set of visual tools that a software developer can group together to build a user interface. This process requires the compiling and bundling of the application's user interface into the application to view the application using a simulator or the intended computing device (e.g., iPhone).

Yet another development approach is typically used in the development for Android, Windows Phone 7, and Adobe Flex. This development approach involves use of user interface metadata (i.e., an XML document) to describe the user interface. The metadata is created by the developer at development time and is either compiled into code, into an intermediary format to be interpreted, or is interpreted by the client computing device at application runtime.

Each of these approaches is undesirably time-consuming because of the waiting time until the new user interface changes are built into the application and launched on a device or simulator/emulator. The application is also limited to displaying only the user interface definitions compiled into the application. Any changes made to the user interface after compiling will not be reflected at runtime, unless the code is compiled again.

Accordingly, it will be appreciated that conventional software development tools and techniques of the prior art for building user interfaces do not enable the developer to make changes to an application while the application is running, or to make changes while viewing the user interface in its final form. Rather, prior art techniques generally involve creation of code, compilation of code, and then viewing the resulting user interface in its final form. If changes need to be made, the code has to be rewritten, compiled, and then run/viewed. This approach is limiting because it doesn't give the developer a view of how the software application (“app”) will actually appear on the device while making changes. A developer generally needs to compile and run the development project for the new user interface changes to appear on a device or simulator/emulator. Thus, a developer must wait until the process is completed and the app is restarted before seeing and testing the user interface changes reflected in any re-written code. The restarting of the app requires the developer to navigate through the app to the area containing the change each time a user interface change is made. Therefore, the conventional development process is undesirably time-consuming and inefficient, and adds time to the cycle of making user interface changes and viewing these changes on a device or simulator.

Additionally, it should be noted that user interfaces for a software application are built using the technologies available for the specific platform on which the software application is intended to run.

For example, user interfaces for native iOS applications are built using iOS specific classes. FIG. 1 shows an exemplary login screen 100 displayed on an iOS device 101 with username 102 and password 104 text fields and a login button 106. FIG. 2 shows the user interface 100 in terms of iOS user interface classes. The iOS user interface class UIWindow 200 has a reference to a UIViewController 202, which has a reference to a UIView 204. The UIView 204 contains a hierarchy of user interface controls 206-214 that make up the screen's user interface.

Each user interface class has properties associated with it. Exemplary properties for an iOS UILabel (e.g., 210) are shown in FIG. 3. Exemplary properties are X 302, Y 304, width 306, height 308, text 310, textColor 312, and backgroundColor 314, as shown in FIG. 3.

By way of example, and consistent with the prior art, a developer may create an iOS UILabel using the exemplary Objective-C code shown in FIG. 4. The exemplary code creates a new UILabel instance 400, sets the properties as shown at 402, and adds the UILabel to a view as shown at 404. The programmatic building of a user interface is a common conventional approach to building user interfaces.

Accordingly, an application built for one platform, e.g., iOS, will have to be modified and/or rebuilt for another platform, such as Android. Thus, if an application is intended to be run on multiple different heterogeneous devices, e.g., running on different platforms and/or with varying screen resolutions, etc., a developer using today's tools builds for one device and installs the app on several devices to test. Therefore, the undesirable wait times associated with developing a single application for a single application/device are multiplied and exacerbated because of the time it takes to make changes and/or install/develop the app on additional devices intended to run the app.

Some software development products and/or techniques exist for implementing a “build once, run anywhere” development model. In such a model, software applications may be built using logical elements that are abstracted and separate from specific code for a specific OS platform. A single build is then “interpreted” to create platform-specific code for each OS platform. Although these products allow a developer to design an application and user interface at a higher conceptual level, they still require compiling and/or interpreting steps. Accordingly, they share some of the disadvantages discussed above. However, one of the more significant limitations of such products and/or techniques is that they support only a limited of features/functionality, etc. that conceptually is the lowest common denominator—i.e., only that certain functionality that is capable of being implemented on multiple different OS platforms. Accordingly, such products prevent development of native OS applications that are rich in platform-specific features/functionality, and thus are generally undesirable.

What is needed is a system and method for user interface management that allows a developer to view the user interface, make changes, and view the revised user interface without enduring the typical re-coding, re-compiling, re-running process. In other words, what is needed is a system and method for runtime user interface management.

### SUMMARY

The present invention provides a system and method allowing modification of a software application's user interface screen after compilation and/or distribution. Changes to the interface are permitted during runtime of the application, by associating a unique identification code with each user interface control of the screen. The identification code is used outside of the application to reference the controls, and to update associated information for displaying the controls. The updates may be provided as properties associated with specific identification codes contained in the application, e.g., as a playlist document created and/or received after compiling and distribution of the software application to client devices. The application includes a software development kit (SDK) for managing the receipt and application of playlist updates, prior to display of the user interface by the application. The system enables direct display and manipulation of user interface control properties in creating playlists, and manages playlist distribution, e.g., to enable multivariate testing.

One aspect of the present invention provides a computer program product in the form of a software development kit for integration with source code to build a software application for displaying a user interface screen comprising at least one user interface control, the source code identifying original properties for displaying each user interface control. In one embodiment, the software development kit comprises code for: assigning a unique identification code to each user interface control identified a view hierarchy corresponding to the user interface screen; creating a document identifying each assigned unique identification code and associated original properties for each user interface control of the view hierarchy; transmitting the document to a server; requesting from the server any playlist corresponding to the software application; and before display of the user interface screen, applying any updated properties from any received playlist to the view hierarchy to cause display of the user interface screen in accordance with the updates provided in any received playlist. A server for distributing the SDK is provided also.

In accordance with another aspect of the present invention a client computing device for providing runtime user interface management is provided. The client computing device comprises a microprocessor, a memory and microprocessor-executable instructions stored in the memory and executable by the microprocessor to: display a user interface screen comprising at least one user interface control, the user interface screen being displayable in accordance with original properties contained in a software application; create and store in the memory a view hierarchy for displaying each user interface control of the user interface screen, the view hierarchy identifying each user interface control and its associated original properties; assign in automated fashion a unique identification code to each user interface control identified in the view hierarchy; create a document identifying each assigned unique identification code and its associated original properties for each user interface control; transmit the document via a communications network; request and receive from a server any playlist corresponding to the software application; and during runtime of the software application and before display of the user interface screen, apply to the view hierarchy any updates from any received playlist. As a result, during runtime of the software application, cause display the user interface controls and user interface screen in accordance with the view hierarchy as updated during runtime by any changes contained in any received playlist.

In accordance with another aspect of the present invention, a user interface management device for providing runtime user interface management is provided. The user interface management device comprises a display device, a microprocessor, a memory, and microprocessor-executable instructions stored in the memory and executable by the microprocessor to: receive a document identifying at least one unique identification code and its associated original properties for each user interface control of a view hierarchy created during runtime of a software application for displaying a user interface screen comprising at least one user interface control; display via the display device a list of each unique identification code and its associated original properties; receive input providing changes to the list; create a playlist document reflecting changes to the list; and transmit the document via a communications network.

### BRIEF DESCRIPTION OF THE FIGURES

An understanding of the following description will be facilitated by reference to the attached drawings, in which:

FIG. 1 is an image of an exemplary iOS user interface window of the prior art;

FIG. 2 is a block diagram illustrating an exemplary prior art hierarchy of iOS user interface objects corresponding to the window of FIG. 1;

FIG. 3 is a block diagram illustrating an exemplary association between an iOS UILabel and associated properties consistent with the prior art;

FIG. 4 is an exemplary listing of Objective-C code that could be used to programmatically create an iOS UILabel, set properties, and add the UI control to a view consistent with the prior art;

FIG. 5 is a system diagram showing a Runtime User Interface Management System (RUIMS) in accordance with a development mode in accordance with an exemplary embodiment of the present invention;

FIG. 6 is a block diagram illustrating relationships among logical components of an Application Definition Document (ADD) in accordance with the present invention;

FIG. 7 is an exemplary JSON document illustrating the structure of an exemplary Application Definition Document (ADD) in accordance with the present invention;

FIG. 8 is an exemplary JSON document illustrating the structure of an exemplary User Interface Definition Document (UIDD);

FIG. 9 is a system diagram showing a Runtime User Interface management System (RUIMS) in accordance with a production mode in accordance with an exemplary embodiment of the present invention;

FIG. 10 is an image of an exemplary user interface window displayed by a UI Management Device, showing how user interface controls and properties may be presented to a developer and manipulated;

FIG. 11 is a flow diagram illustrating an exemplary method for retrieval of resources by a RUIMS development library of FIG. 5;

FIG. 12 is a flow diagram illustrating an exemplary method for retrieval of resources by a RUIMS runtime library of FIG. 9;

FIG. 13 is an exemplary JSON document illustrating the structure of an exemplary Application Definition Document (ADD);

FIG. 14 is an exemplary HTTP URL for retrieving resources in accordance with FIG. 5 and FIG. 9;

FIG. 15 is an exemplary JSON document illustrating the structure of an exemplary use of keys for choosing an exemplary iOS UILabel;

FIG. 16 is an exemplary JSON document illustrating an exemplary Application Definition Document (ADD) containing a key dateTime used to identify which image resource is displayed;

FIG. 17 is an exemplary JSON document illustrating how the RUIMS system may be used in the context of A/B testing for choosing one of two screens;

FIG. 18 is an exemplary document illustrating a playlist that may be used to communicate property changes for user interface controls assigned unique identification codes;

FIG. 19 is a flow diagram of an exemplary method for runtime user interface management involving developing a software application and displaying the application's user interface in accordance with updated properties contained in a playlist in accordance with an exemplary embodiment of the present invention;

FIG. 20 is a flow diagram of an exemplary method for runtime user interface management involving developing a software application, developing a playlist of changes at a user interface management device, and displaying the application's user interface in accordance with updated properties contained in the playlist in accordance with yet another exemplary embodiment of the present invention;

FIG. 21 is a flow diagram of an exemplary method for runtime user interface management involving developing a software application and selective displaying the application's user interface in accordance with updated properties contained in a playlist to provide multiple versions of a user interface in support of multivariate user interface testing, in accordance with still another exemplary embodiment of the present invention;

FIGS. 22-30 are graphical user interface windows illustrating an exemplary use of the RUIMS system to perform A/B testing of alternative user interface screens on mobile computing devices; and

FIG. 31 is a schematic showing an computer in accordance with an exemplary embodiment of the present invention.

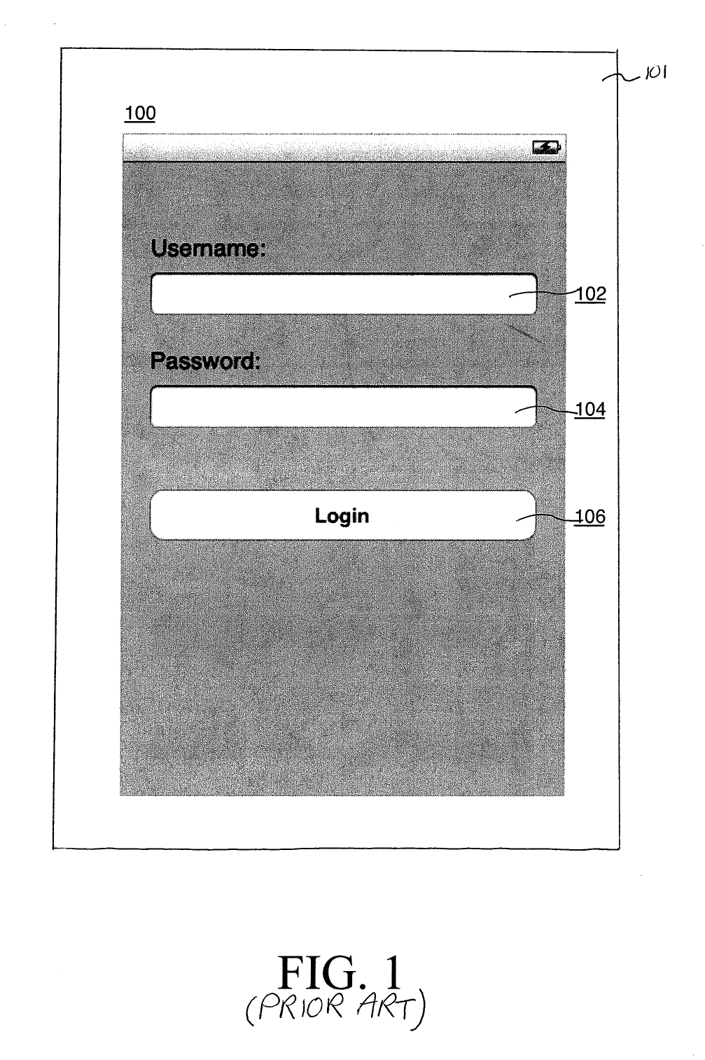

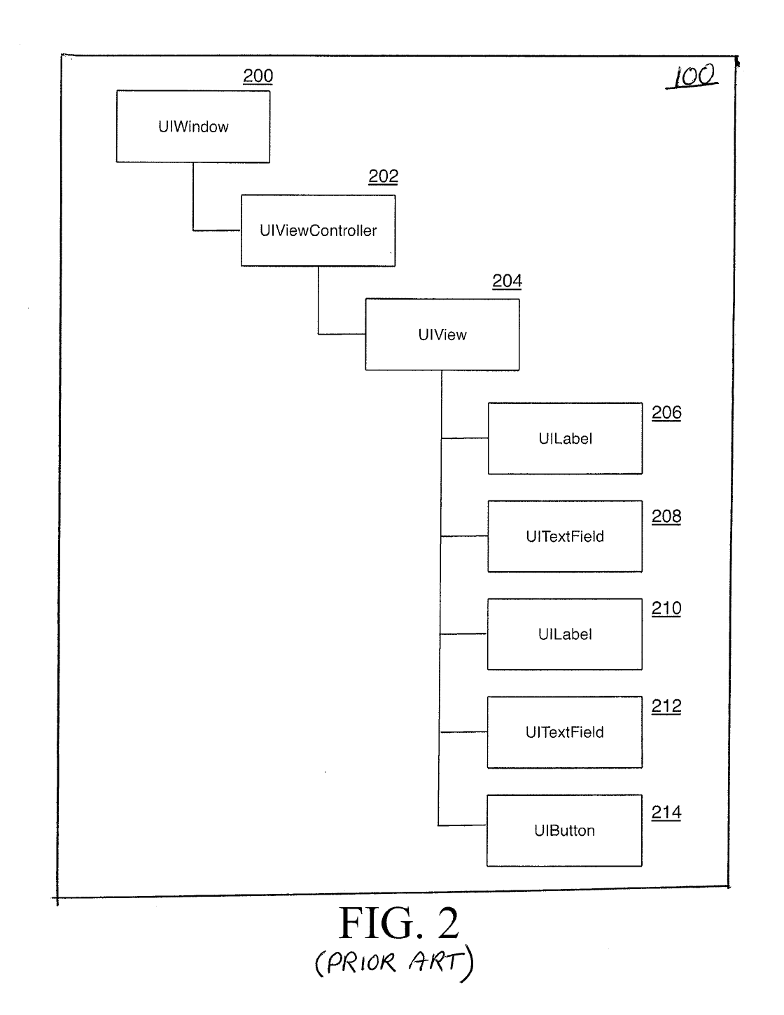

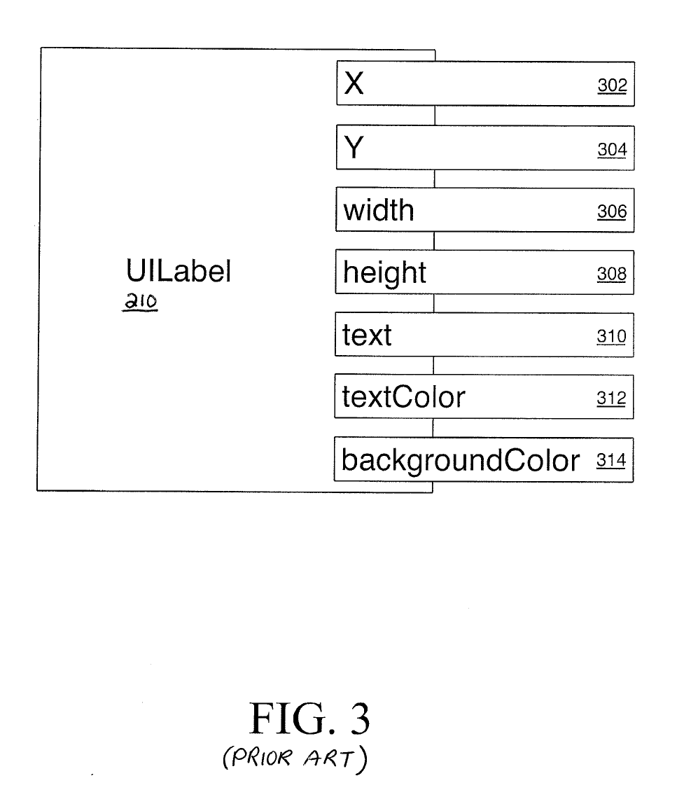

### DETAILED DESCRIPTION

The present invention relates to a system and method for providing runtime user interface management, i.e., user interface management at the time of, concurrently with, and/or during execution of the software application of which the user interface is a part, i.e., during “runtime.” As user herein, the term “software application” is used in a very broad and non-limiting fashion to include any build of any software application, and thus the term expressly includes conventional executable binary files as well as application package files (APKs) of the type used in Android OS platforms, as well as HTML5, scripts and/or other scripting languages or techniques. The system and method for runtime user interface management allows a software developer to view a runtime version of the user interface in development, make changes, store the changes in a persistent data store for subsequent distribution, and view the revised runtime version of the user interface without having to endure the re-coding, re-compiling, and re-running processes typical of conventional user interface development processes. Accordingly, changes to a user interface screen at a client computing device are made in real time, essentially immediately/instantaneously, after inputting changes (at a user interface management device)—without a need to recompile or otherwise rebuild and/or redistribute the software application.

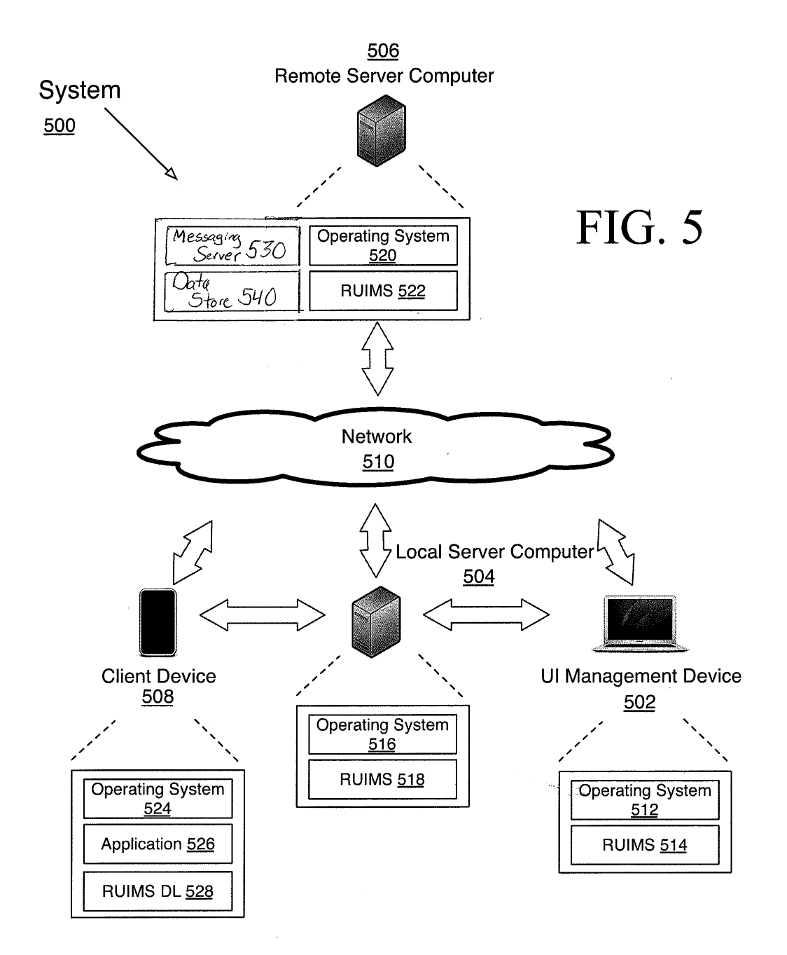

Referring now to FIG. 5, an exemplary Runtime User Interface Management System (RUIMS) 500 is shown. The RUIMS 500 is effectively a platform that replaces both current programmatic and visual GUI-development tools. RUIMS manages the user interface and supporting resources for a software application, as shown in FIG. 5. RUIMS is different from the prior art because the RUIMS system enables the building and manipulating of the user interface during runtime, while the application is running on client computing devices, such as Client Device 508. Typically, this is impossible or prohibited in that current tools view the development process as compiling code or metadata into the final application. This present invention effectively extends the development process to updating the user interface while the application-in-development is running, by requiring the application to include software that can communicate with the IDE during runtime, e.g., by communication with Server Device 506, which receives, stores and communicates information about changes to user interfaces.

The Client Device 508 retrieves user interface updates from a Server Computer 506. By way of example, Server Computer 506 is a special-purpose computing device that can include any conventional general purpose computing device hardware configured with any conventional operating system 512 and other server software, and a special-purpose RUIMS 522 consistent with the present invention. As described herein, RUIMS 522 defines rules for when the user interface changes can be displayed, defines rules for personalization, and has the ability to add and capture analytics as the design of the user interface changes. By way of example, rules can be defined as a combination of metadata describing properties or attributes used to describe the parameters relating to a set of steps or algorithms, along with code that actually implements the steps or algorithms. An exemplary rule might be to only show a user interface change or version of an A/B test if a mobile phone running the software application is presently geo-located within a bounding perimeter. In this example, the metadata would contains the latitude and longitude coordinates of the containing bounding perimeter and specific code is created to compare the device's location with the bounding perimeter defined in the metadata. The pairing of metadata and code enables the system to be flexible with respect to adding rules to the system. Another exemplary rule provides for personalization and/or customization of the user interface (e.g., to show targeted advertising or promotions, to show enhanced to decreased functionality, to show different interface versions, etc.), e.g., as a function of a user's profile, account status, or any relevant business logic.

Further, RUIMS 522 receives messages responsive to changing of a user interface, and sends messages to cause updating of applications running on client devices, such that those changes will be incorporated into the user interface displayed on the Client Device 508. Each message includes information relating to a specific user interface control and related parameters. For example, the message's information may identify a specific user interface control, its properties, values and/or data type. SDK code of the associated software application provides instructions for calling such information to make the changes to the user interface control that are reflected by the content of the message.

For an application to be developed using RUIMS, the developer of the application creates an account for use of the RUIMS system. This can be accomplished using conventional account creation techniques, e.g., by creating a user account using the RUIMS application 514 on a UI Management Device 502. By way of example, a UI Management Device 502 is a special-purpose computing device that can include any conventional general purpose computing device hardware configured with any conventional operating system 512 and web browser and other software, and a special-purpose RUIMS 514 consistent with the present invention that is configured to store changes to an interface (e.g., data store 540) at Server Computer 506, and to communicate messages to the Server Computer 506 to inform the server of the changes (e.g., using a conventional messaging server 530). The messaging server 530 may be used to enable all network communication described herein among the Server Computer, UI Management Device and Client Device. The UI Management Device 502 communicates with the Server Computer 506 via Network 510 to register the user and to create an account. In one embodiment, the Network 510 is a public packet-switched network, such as the Internet, and this communication is done using conventional HTTP/HTTPS, but any current or future network communications technology using both encrypted and non-encrypted communications could be used.

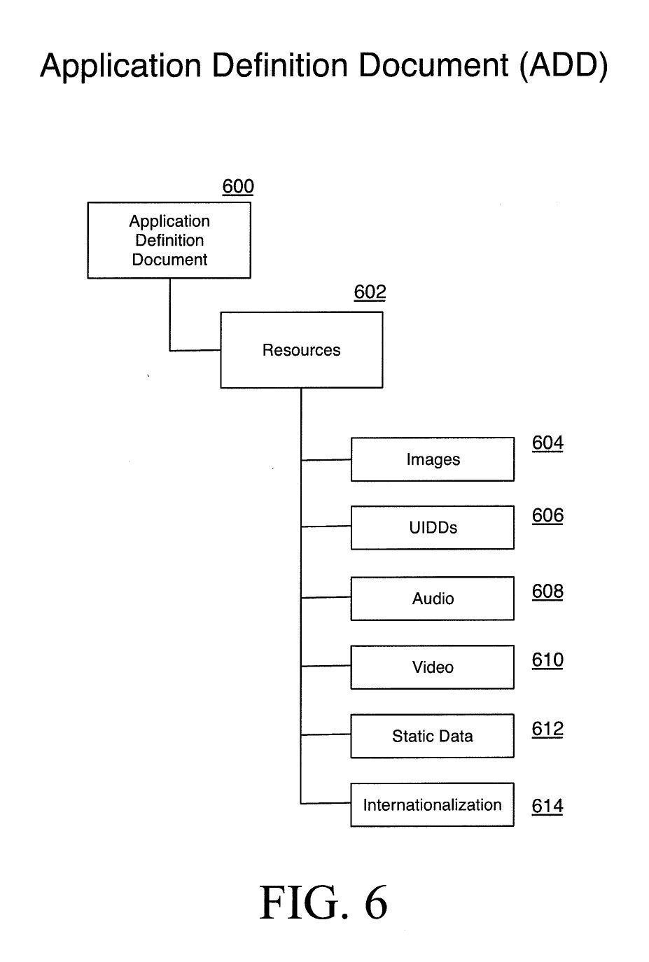

After a software developer has established a developer account with Server Computer 506, the developer can create an Application Definition Document (ADD) for a new application in development, e.g., using the browser of UI Management Device 502 to initiate the creation of the ADD which is sent to Server Computer 506 for storage in data store 540. In accordance with the present invention, the Application Definition Document (ADD) 600 is used to describe all of the resources required to support the application in development. An exemplary ADD is shown in FIG. 6. Examples of resources 602 include images 604, screen definitions 606, audio 608, video 610, static data 612, and internationalization strings 614, as will be appreciated by those of ordinary skill in the art. Resources are used by the application in displaying the user interface. Consistent with an exemplary embodiment of the present invention, the RUIMS system 500 (e.g. RUIMS 522 at Server Computer 506) assigns a unique ADDID to each ADD upon the ADD's creation. The ADDID uniquely identifies the ADD and is used to reference the ADD in the RUIMS system.

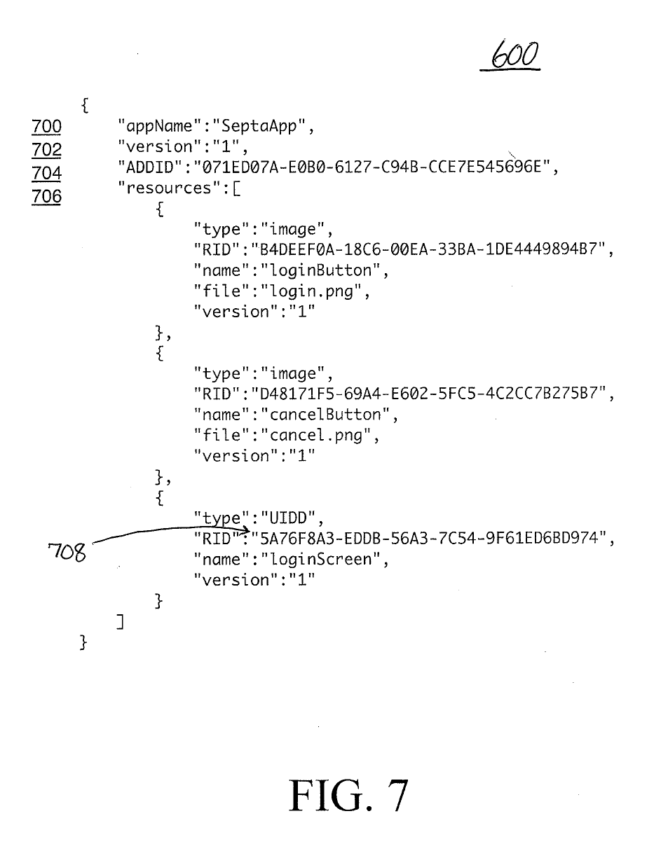

Referring now to FIG. 7, exemplary code is shown that illustrates the structure of an exemplary ADD 600 in accordance with the present invention. As shown in FIG. 7, the ADD 600 contains an application name (appName 700), a version number 702, the ADDID 704, and a list of associated resources, as shown at 706. In FIG. 7, the ADD 600 is shown as a JSON document. It will be appreciated that the ADD is not format-specific and can be represented as JSON, XML, in a relational database, NOSQL database, plist, HashMap, or any other format used to represent data and relationships between data including platform specific serialization (i.e. Java binary serialization). The essence of the ADD is that it identifies all resources used to display the user interface including the definition of all UI controls, images displayed in the UI, and any resources such as video files, audio files, and internationalized text strings and is uniquely identifiable by the ADDID. Each ADD is managed in a version control system. Version control systems are conventional, and their use in software development is well-known.

An application in development or an application in production, e.g., Application 526, may be loaded and stored on a Client Device 508 for development/testing/production purposes. Exemplary client computing devices include mobile telephones such as Nokia® Asha mobile phones running the Nokia® Series 40 OS software, smartphones such as the Apple® iPhone running iOS software, Samsung® Galaxy Nexus phones running Android® OS, HTC® Titan II phones running Windows® Phone 7 OS software, tablet PCs such as the Apple® iPad® and Blackberry® Playbook 2, laptop computers such as PCs running Windows OS software, and PCs running Unix-based operating systems such as Macintosh® OS X.

During execution of the Application 526, the Application 526 uses the ADDID and version number (if applicable) to retrieve the correct user interface resources to display the Application's user interface. If the version number is omitted when requesting a resource the system defaults to a version defined by the system, such as the last-created version in a chain of versions.

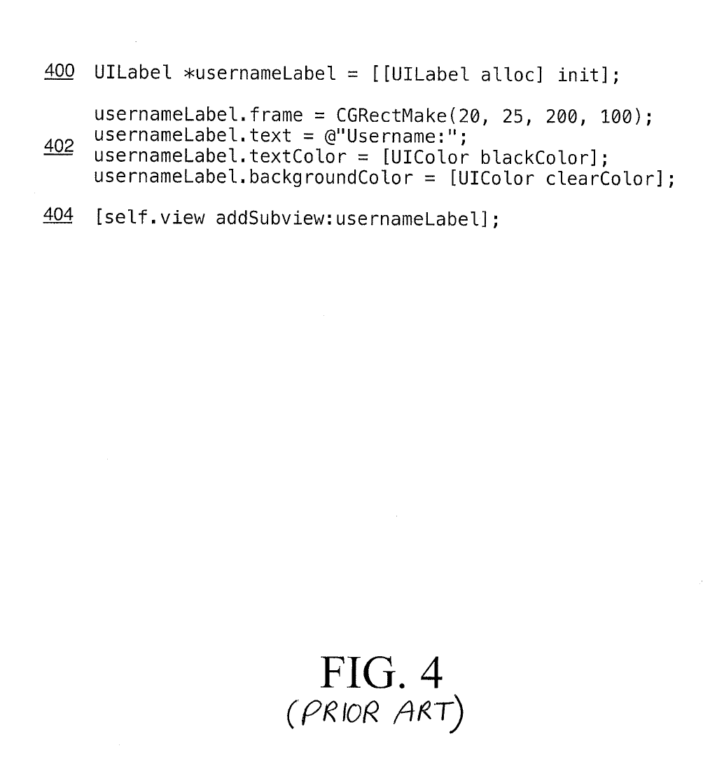

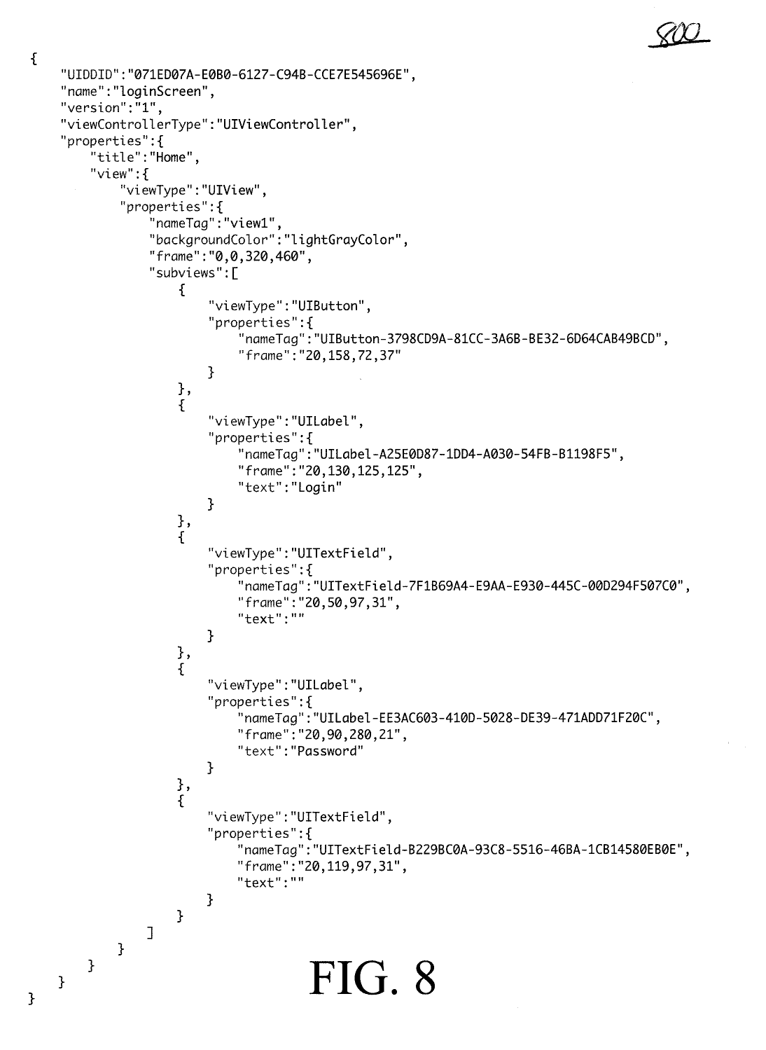

In accordance with the present invention, the developer configures the ADD 600 to include references to User Interface Definition Documents (UIDDs) (see FIG. 7). Each UIDD is assigned a unique UIDDID that is used within the system to reference the UIDDs, e.g., by Server Computer 506. Consistent with the present invention, the UIDDs are structured to include definitions for all of the user interface controls that will be created when the user interface is displayed. Thus, the UIDD contains the necessary information to build the user interface with the end result of a user interface that acts and behaves the same way as if it was built programmatically as in FIG. 4. It will be appreciated that the UIDD is metadata, and may be stored as JSON or XML data, or as any other metadata type. For example, the UIDD can define complete screens, views composed of multiple user interface controls, or a single user interface control. An exemplary UIDD 800 is shown in FIG. 8.

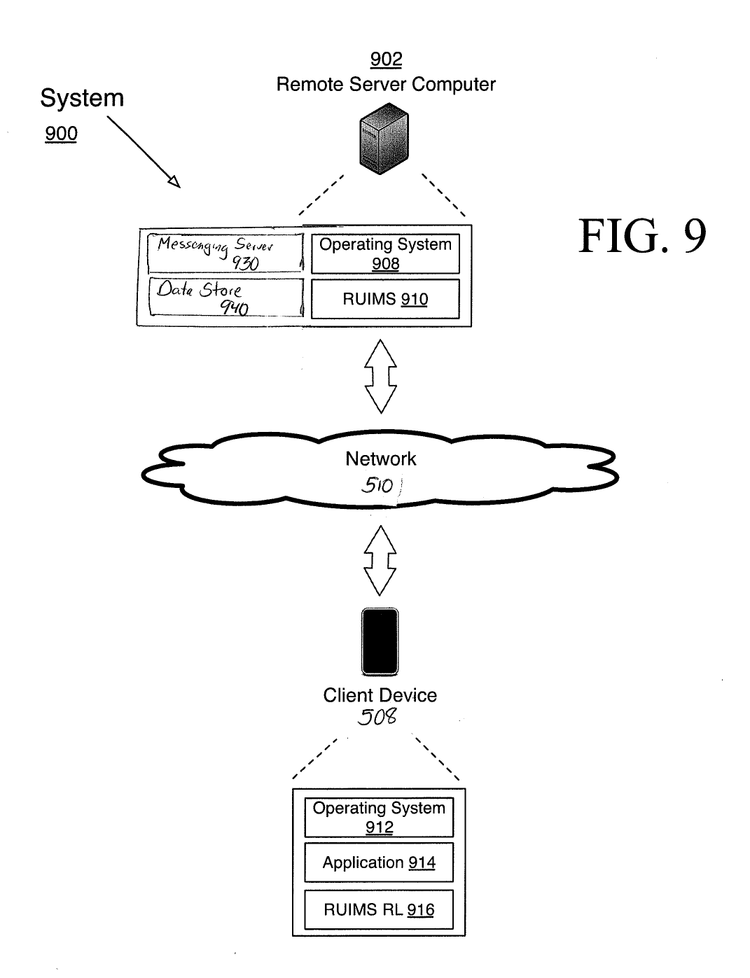

The RUIMS 500 can operate in a development mode as shown in FIG. 5, or in production mode as shown in FIG. 9. The development mode allows the developer to make changes to the Application 526/914 and view these changes in real-time on a device (e.g., Client Device 508) or simulator. In an exemplary embodiment, production mode downloads resources only when required and will cache resources to decrease the downloading of unchanged content/resources. In the examples described herein, the modes are described separately for illustrative purposes, but in certain embodiments the code of the RUIMS 500 may support both modes and the current use mode could be toggled from one mode to the other, or may be supported simultaneously without the need for toggling.

Building of a user interface is an essential part of each GUI-based application. Instead of using the platform-specific approach such as NIB files on iOS or building the user interface programmatically, the developer may call into the RUIMS Development Library (RUIMS DL) 528 or RUIMS Runtime Library (RUIMS RL) 916 to pass in the user interface name or ADDID. The RUIMS DL 528 and/or RUIMS RL 916 builds the user interface by returning the user interface objects back to the calling application. If the UIDDID or user interface name does not match an existing UIDD the RUIMS system 500 can be configured to create a new empty UIDD ready for customization using the RUIMS system 500.

For a developer to work on the Client Device 508 with RUIMS in development mode, the developer downloads and installs on the Client Device 508 the RUIMS DL 528, which runs inside of the developer's Application 526 on the Client Device 508, as best shown in FIG. 5. The RUIMS DL 528 is configured with the ADDID and any other authorization requirements for the given environment. The developer's Application 526 may be configured (e.g. by configuring RUIMS DL 528) to run in development mode.

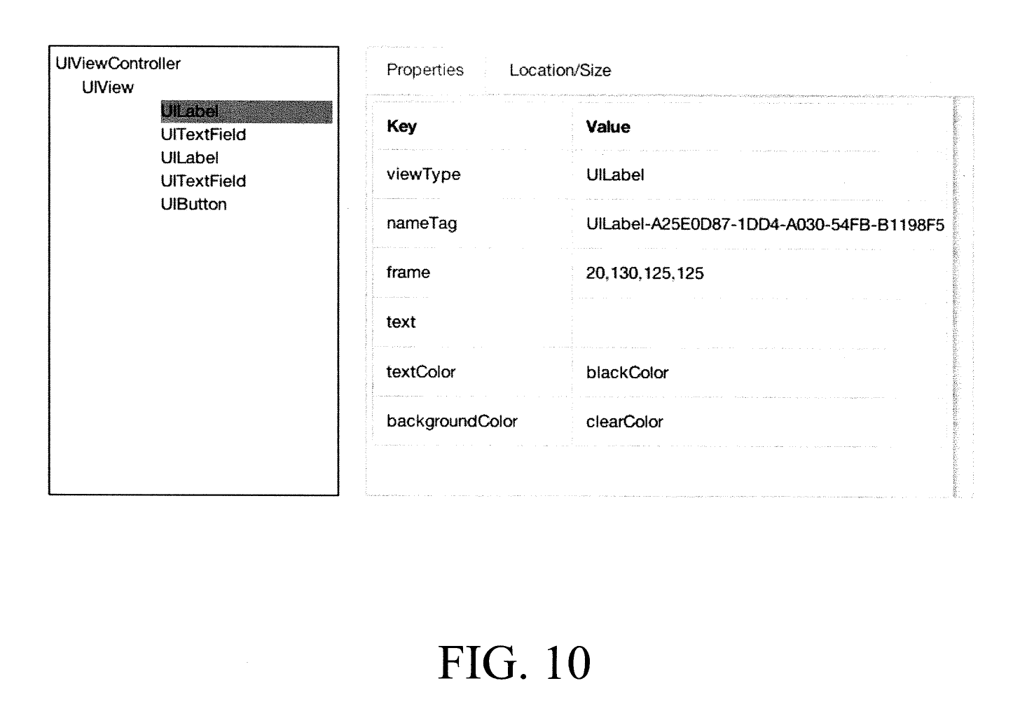

A developer can create, update, and delete user interface screens for the Application 526 using a UI Management Device 502. More specifically, the user operates the Client Device 508 to navigate within Application 526 to a user interface screen to be modified. When navigating to such an interface screen, RUIMS 528 sends a message (via messaging server 530) from the Client Device 508 to Server Computer 506 that is routed to the UI Management Device 502. RUIMS 514 of UI Management Device 502 receives the message and calls the corresponding UIDD associated with the displayed screen from the Server Computer 506. Upon receiving the called UIDD, RUIMS 514 displays a breakdown of the screen displayed on the Client Device 508 in a property editing screen, as seen in FIG. 10, e.g., by displaying the list of UI controls/properties/values and other information contained in the UIDD. In the example of FIG. 10, the property editing screen displays controls and properties of a user interface view (e.g., UIView) associated with a corresponding screen being displayed on the Client Device 508. Via the property editing screen, the developer can view the properties and actions associated with a user interface control and change the property's value as seen in FIG. 10. For example, the developer may enter text into a text field, or select a new text color from a drop-down menu of text colors, or specify a new location and size of an associated UI control, by typing X location, Y location, width and height values into an associated “frame” value field.

In this screen, the developer operating the UI Management Device 502 can also delete controls (e.g., a text field, a button, or other object) from a screen by deleting them from the list of controls in the window in FIG. 10, or add controls to a UI screen, by adding them to the list of controls, e.g., by dragging and dropping UI controls from a list provided by the Server 506 and/or the UI Management Device 502. The list of controls that can be added is communicated from Server Computer 506, and is a function of the relevant OS platform of the application (e.g., a list of iOS controls would be provided when developing an iOS application, and a list of Android controls would be provided when developing an Android application). The lists may be stored in the data store 540.

Accordingly, it should be appreciated that the system can be used not only to modify an existing screen but to create a new screen, e.g., by editing a blank UIDD to create a new UIDD corresponding to a new screen.

The System 500 enables a developer to make UI changes to an Application 526 running on a Client Device 508, using the UI Management Device 502. For example, when a developer makes a property change to a UI control of the Application 526 using the UI Management Device 502 interface by changing the controls, properties and/or values shown in FIG. 10, a message is sent from RUIMS 514 to RUIMS 522 of the Server Computer 506. In response to receipt of the message, the Server Computer 506 looks up the clients bound to the same development session and routes the message to the corresponding Client Devices 508. Further, the changed UIDD may be stored persistently (e.g., in the data store 540) at the Server Computer 506 for subsequent retrieval and/or distribution to the same or other Client Devices 508.

It should be appreciated that the System 500 enables a developer to make UI changes to each instance of the Application 526 running on multiple Client Devices 508 in parallel using the UI Management Device 502. The ability to view a user interface on a device or in a simulator and make changes to the user interface on multiple devices in parallel enables developers to reduce development time by validating what the user interface will look like on each distinct device of a plurality of heterogeneous devices. An example of this is the same application running on an iPhone® 4 and iPhone® 5 or iPad®, which have different screen sizes.

The ability to change the user interface and supporting resources of an application while the application is running is enabled by a messaging system (e.g., messaging server 530 at Server Computer 506) between the UI Management Device 502 and the Client Device 508. When an Application 526 on a Client Device 508 is running, the Application 526 will send messages to Server Computer 506 (specifically, messaging server 530) using RUIMS DL 528, communicating details about the currently visible user interface screen, including the current screen as well as the definition of the screen. RUIMS DL 528 is configured to send messages to RUIMS 522 and to the corresponding UI Management Device 502 all sharing the same session. Any changes to the Application's UI are reflected in the RUIMS 514 user interface displayed at UI Management Device 502. Messages from RUIMS DL 528 include but are not limited to the changing from one screen to another, that a user modified or touched a UI control, or even that the user moved the UI control to a new location. The UI Management Device 502 is configured to receive this message and notify the developer of the current UIDD on the Client Device 508. The developer can make application changes using RUIMS 514 such as changing the text on a label, adding a new button, or setting the click of a button to call a method defined in code currently running on the device. These changes are sent as messages through the Server Computer 506 to the Client Device 508. The Server Computer 506 (or 902) is responsible for managing the list of Client Devices 508 and UI Management Devices 502 currently running. The Server Computer 506 (or 902) is responsible for routing messages to the correct Client Device 508 or UI Management Device 502 based on a developer's access to a given app. More specifically, a developer has access to a given app by logging into RUIMS 522 using a RUIMS 514 browser interface for example. A messaging session is created between the RUIMS DL 528 and RUIMS 514 though the configured use of an application id and application version. The combination of application id and application version enables RUIMS 522 to pair (route) the messaging between RUIMS DL 528 and RUIMS 514.

The exemplary embodiment of FIG. 5 shows the local Server Computer 506 and the UI Management Device 502 as separate logical and/or structural components for hosting the RUIMS system software. However, in alternative embodiments, a local Server Computer 504 may be provided with RUIMS software 518, in addition to Server Computer 506, and may be provided as a separate logical and/or structural component, or may be hosted on the UI Management Device 502 without a separate RUIMS Server 506. The hardware and software of local Server Computer 504 can be largely conventional, as described above with reference to Server Computer 506. Local Server Computer 504 includes a special-purpose RUIMS 518 that is analogous to RUIMS 522. Local Server Computer 504 acts as a proxy server in communication with Server Computer 506, and messages may be transmitted locally to local Server Computer 504 to circumvent firewall issues and/or latency that would otherwise be associated with use of Server Computer 506.

The messaging can use any standard or proprietary messaging protocol used on a local or wide area network. Messages can be sent either encrypted or unencrypted, with or without a checksum or hash code to protect against tampering. By way of analogy, the RUIMS messaging mechanisms may operate in a manner similar to the conventional Java Message Service (JMS) implementation used in other contexts.

The RUIMS DL 528 receives the message from the UI Management Device 502 instructing the RUIMS DL 528 code to perform an action. An exemplary action is updating the text for a UILabel, e.g., to “USERNAME.” In response, the RUIMS DL 528 code looks up the current screen, finds the label with tag equal to “username”, and updates the label with the text “USERNAME.” If a copy of the UIDD is stored locally on the Client Device 508, the UIDD is updated in RUIMS 522 with the change. In an exemplary embodiment, the RUIMS DL 528 then creates a response message including the success or failure status of the original message and sends the message back to UI Management Device 502 that requested the change. The UI Management Device 502 accepts the response message and will update the UIDD document stored at Server Computer 506 associated with the change, saving the change by calling the local Server Computer 504 or Server Computer 506. This ensures all changes made by the developer are captured and stored on both the Client Device 508 and UI Management Device 502. Optionally, the UI Management Device 502 displays the status of the response message to the developer. Alternatively, the UI Management Device 502 updates the UIDD stored on the Server Computer 506 before sending a message or in parallel to sending a message to the Client Device 508, but this process does not take into account if the Client Device 508 will successfully interpret the message.

One advantage of embodiments including a local RUIMS Server Computer 504 is a reduction in the latency of managing the messaging and system updates between the Client Device 508 and the UI Management Device 502. This reduction in latency is particularly important to the development process. If the Client Device 508 can't find or communicate with a local Server Computer 504 the Client Device 508 can optionally communicate with the Server Computer 506.

During development of an application the RUIMS DL 528 will retrieve user interface resources from the local Server Computer 504 if available or from the Server Computer 506 if that server is being used for the development process. As noted above, local Server Computer 504 may be preferred for this purpose to reduce latency. If the RUIMS DL 528 is connected to a UI Management Device 502, a development session is created and all resources retrieved are based on the most recent active version of the ADD and any changes made during the session. If the RUIMS DL 528 is not connected to a UI Management Device 502, all resources retrieved are based on the most recent active version of the ADD resident at the Client Device 508.

A feature of RUIMS is the ability for the system to utilize a different version of the ADD depending on the runtime state of the application. This relationship can be thought of as a session between a Client Device 508 and a UI Management Device 502. This feature enables developers to work independently on user interface changes without impacting the work of other developers making changes to the same app. If a developer is running an app but the app doesn't have a UI Management Device 502 connected, the app will display the most recently saved version of the ADD and associated resources. If the app does have a UI Management Device 502 connected, the app will display any updates made by the UI Management Device 502. These updates may not have been saved as part of the most recent version and would only be visible to the Client Devices 508 connected to the UI Management Device 502.

In the preceding description, all exemplary user interface changes have been described as originating from the UI Management Device 502 and being communicated through the Server Computer 504/506 to the Client Device 508. However, in alternative embodiments, user interface change requests may be initiated from the Client Device 508. For example, the developer would turn this feature on in the RUIMS DL 528 so the developer can interact with the user interface controls. An example would be the moving of a UI control on the screen by dragging it to position the UI control in a different location. The moving of the UI control would generate a message and the message would be routed through the local Server Computer 504 or the Server Computer 506 to the UI Management Device 502. The UI Management Device 502 validates the requested change, updates the UIDD in the UI Management Device 502, and sends a request to the local Server Computer 504 or Server Computer 506 to store the change to the UIDD. The local Server Computer 504 or Server Computer 506 responds back to the originating Client Device 508 with a response message confirming that the change has been made.

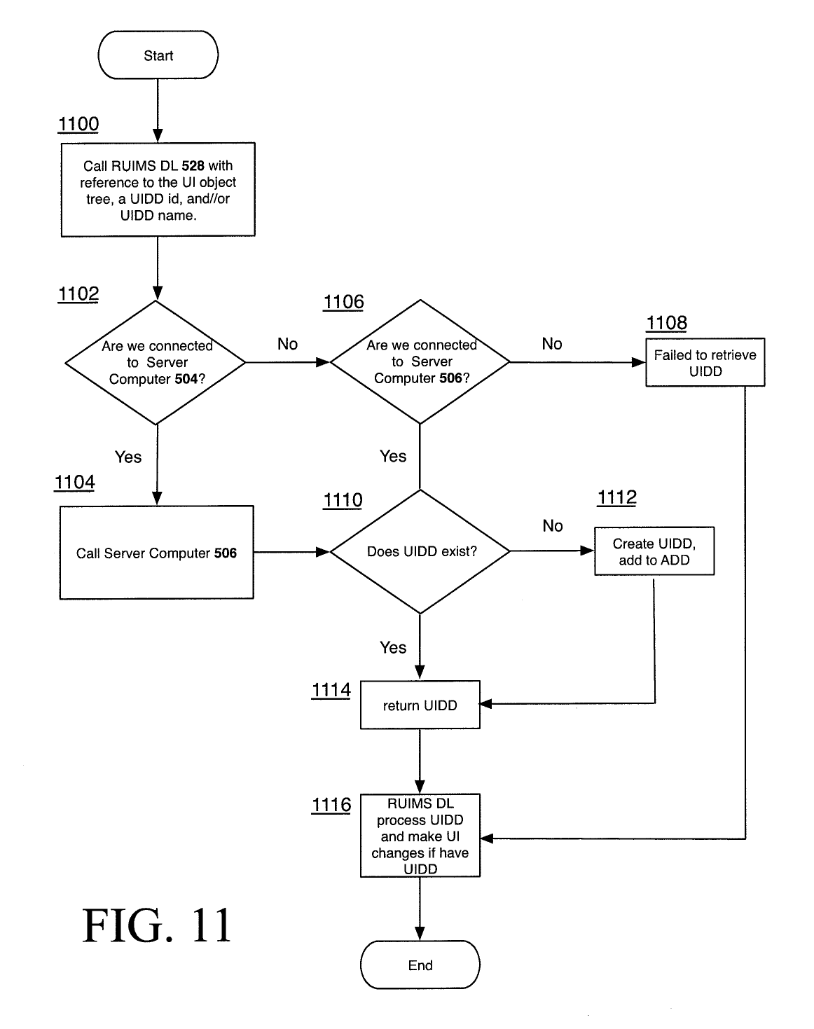

It should be noted that a developer may choose to use RUIMS on an application that already has screens built by a mechanism other than RUIMS. For example, the user interface may have been built programmatically as in FIG. 4 on iOS. In this case, the developer can use RUIMS to modify and enhance the user interface not built with RUIMS. As shown in FIG. 11, the developer can call RUIMS DL 528 and pass in a reference to the user interface object tree pointing to the actual user interface objects, as shown at 1100. Next, RUIMS DL 528 tries to connect to the local Server Computer 504, as shown at 1102. If the RUIMS DL 528 can't connect to a local Server Computer 504, RUIMS will try to connect to a Server Computer 506, as shown at 1102 and 1106. If the RUIMS DS 528 can connect to the Server Computer 506, then processing continues at 1110 as discussed below. If RUIMS DL 528 can't connect to the Server Computer 506, then RUIMS DL 528 will fail to retrieve a UIDD, as shown at 1106 and 1108. If the local Server Computer 504 was successfully called at 1102, then the local Server Computer 504 will call the Server Computer 506 as shown at 1104. The Server Computer 506 then checks to see if the UIDD exists as shown at 1110. If the UIDD does not exist, a new UIDD will be created and added to the ADD, as shown at 1110 and 1112. The found or created UIDD will be returned from the Server Computer 506 back to RUIMS DL 528, as shown at 1114. If a UIDD was found or created the UIDD will be processed and the user interface updates will be made to the object tree passed into RUIMS DL 528, as shown at 1116, and the method ends.

In this exemplary embodiment, the RUIMS system 500 also has a production mode, as shown in FIG. 9. The production mode is streamlined to balance performance with the ability to retrieve updated resources and UIDDs. When the RUIMS system 900 is in production mode the Client Device 906 will generally not receive messages from a UI Management Device (not shown). When in production mode the Client Device 906 is using the RUIMS Runtime Library (RUIMS RL) 916 for communications to the Server Computer 902. The RUIMS Development Library (RUIMS DL) 528 (FIG. 5) and RUIMS RL 916 (FIG. 9) can be separate physical code libraries compiled into an application or one library containing the code for both RUIMS DL and RUIMS RL. An advantage of having one library containing both development and production libraries is the ability to turn on development mode in a production app for testing purposes.

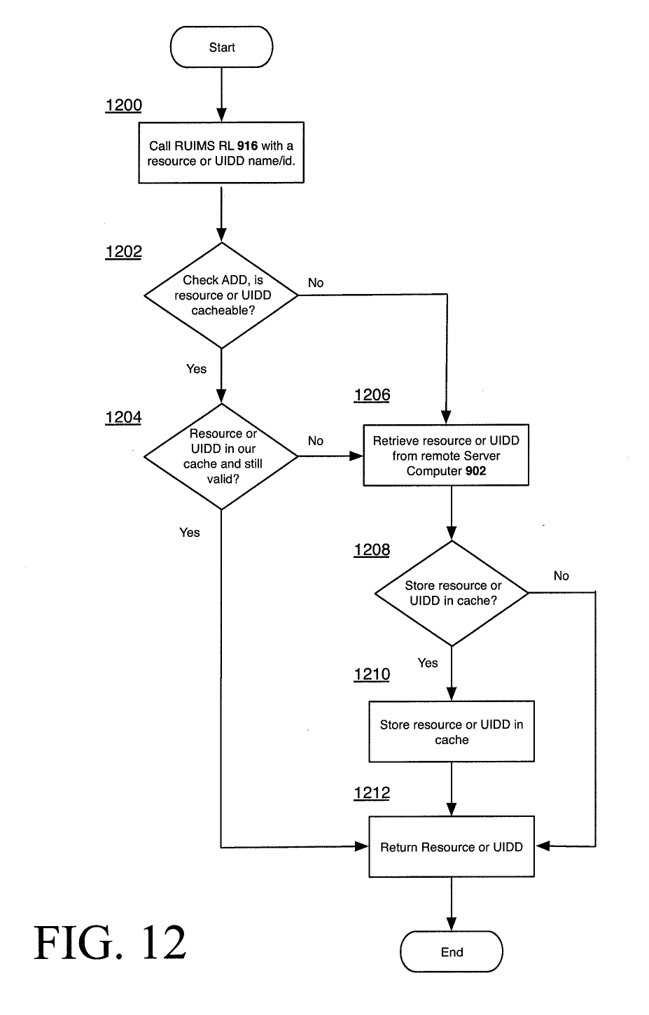

During production mode, the RUIMS RL 916 is responsible for retrieving new resources and UIDDs from the Server Computer 902. An exemplary method illustrating operation the RUIMS RL 916 to retrieve resources and UIDDs at runtime is shown in FIG. 12. In connection with running of the Application 914, the Application's code calls into RUIMS RL 916 and passes in a resource or UIDD name/id, as shown in FIG. 12 at 1200. Next, the RUIMS RL 916 looks up the resource or UIDD and determines if the resource or UIDD is cacheable, as shown at 1202. Examples of local caches include file storage on disk, memory, flash-based memory, or a relational database.

If it is determined in step 1202 that the resource or UIDD is cacheable, then it is determined whether the resource of UIDD is stored in a cache and still valid, i.e., not expired, as shown at 1204. It is determined in step 1204 that the resource or UIDD is stored and still valid, then the called resource or UIDD is returned, as shown at 1212, and the method ends.

If it is determined in step 1202 that the resource or UIDD is not cacheable, then the RUIMS RL 916 retrieves the resource or UIDD from the Server Computer 902, as shown at step 1206.

Alternatively, if it is determined in step 1204 that the resource or UIDD is not stored in the cache, or is stored in the cache but not valid (i.e., expired), then the RUIMS RL 916 retrieves the resource or UIDD from the Server Computer 506, as shown at step 1206.

In either case discussed above, after a resource or UIDD is retrieved from a Server Computer 902 in step 1206, RUIMS RL 916 then checks to determine whether the retrieved resource or UIDD is cacheable, as shown at 1208.

If the retrieved resource or UIDD is determined to be cacheable at 1208, then the resource or UIDD is stored in cache 1210. After the resource or UIDD is stored in the cache, as shown at 1210, and returned in response to the call, as shown at step 1212, the method ends.

Alternatively, if the resource or UIDD is determined not to be cacheable at 1208, then the resource is returned in response to the call, as shown at 1212, and the method ends.

In certain embodiments, RUIMS RL 916 is configured to look for updated resources and UIDDs in a background process and download these updates for storage in local cache, using conventional caching techniques beyond the scope of the present invention. Consistent with the present invention, if conventional caching techniques are used to ensure that all resources 602 are downloaded as a complete package before any of the UI changes can be displayed in the application. This tends to avoid issues related to implementation of updates—e.g., to avoid adding a new image to a screen before the new image has been downloaded to the device before the image is displayed; otherwise the new image control would appear on the screen without the associated image.

In certain embodiments, RUIMS RL 916 is configured with the ability to permit developers to configure rules associated with the updating of resources and UIDDs associated with an ADD in the Client Device 508. The rules may be applied for distributing and/or applying metadata. By way of example, applicable rules may provide that the metadata is applied only when an associated application starts, or when it awakes from a sleep mode, or according to a local time of day, etc. Such rules may be encapsulated within the metadata to which it applies. For example, if a developer does not want newly-updated images to appear in the application until after the user has navigated back to a home screen, or has restarted the application, such rules are stored and configured in the ADD. One reason for wanting this type of logic is so the images or screen fields don't change for a particular application user while the user is in the middle of a wizard or multi-screen process. The Client Device 508 may be configured to display an alert box notifying the user of application interface changes about to be applied giving the option to the user of accepting or delaying the user interface changes by way of configuration parameters included in code during the integration of the RUIMS SDK 528, 916 with the application 526, 914.

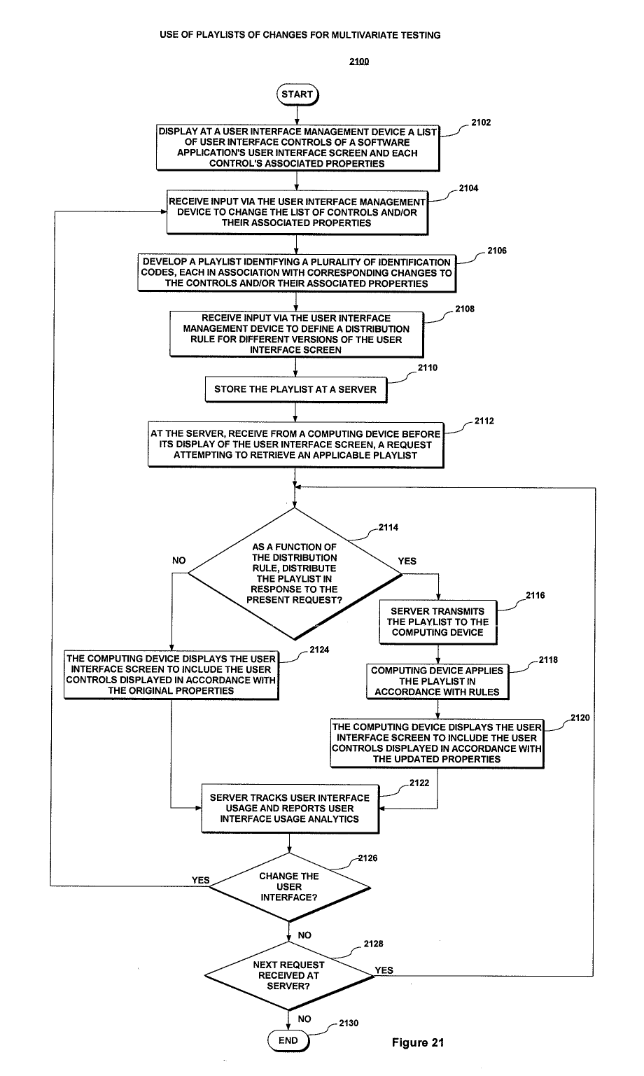

For example, referring again to the example of FIG. 5, the Client Device 508 may request a playlist from RUIMS 522. The playlist contains a list of all of the changes that should be made to a corresponding user interface screen of application on the Client Device 508. Accordingly, the playlist is effectively a list of changes to an existing UIDD. The playlist may be a document (format could be XML, JSON, Apple plist, etc.), and/or may be provided as the content of a message routed by the RUIMS messaging server 530. RUIMS 522 may create this playlist by iterating through all available changes to the UI as defined in UIDDs or other facility for managing UI changes. Each playlist entry has a start time, end time, and a reference to a list of the UI changes. These UI changes could have come, for example, from an A/B or multivariate test. For example, the playlist may define multiple lists of changes to establish multiple corresponding versions (e.g., A and B) in a multivariate (A/B) test. Alternatively, the set of changes could be the result of choosing one of A and B from the set of A and B in a multivariate test. An exemplary multivariate test is discussed below with reference to FIGS. 21-30. Alternatively, a change to the UI might be made going forward to fix a spelling mistake made on the screen, etc. Rules are preferably provided in RUIMS 522 to determine which changes will be applied by each Client Device 508. The playlist is downloaded by RUIMS 528. Preferably, this is done in a background thread so it will not delay the user from accessing the corresponding application and the associated user interface.

Once a new playlist is downloaded, it may be checked for changes to the playlist since the last download. If there are new playlist entries with additional content, the new content (i.e. UI changes, images, etc.) is downloaded and the changes are cached locally. Optionally, a new playlist may be disregarded for efficiency purposes. For example, a new playlist assigning Version B in a multivariate test may be disregarded for efficiency purposes if a prior playlist assigned Version A. The new playlist entry changes may be downloaded without impacting the current screens at this point if all new changes are stored locally on the phone in a directory structure that is only available to RUIMS 528 only after the new playlist becomes the active playlist. So RUIMS 528 tracks the currently active playlist and the new playlist that is being downloaded and processed. In one exemplary embodiment, at predetermined occurrences, such as backgrounding and foregrounding the application, or at predetermined intervals, e.g., every 10 minutes, if a new playlist has been downloaded the current playlist will reference the new playlist. This enables the application to have new changes without requiring restarting of the application. Every time a user navigates to a new screen or back to a screen that was previously displayed, RUIMS 528 checks the playlist for changes to be applied to the screen. RUIMS 528 looks at start time and end time to determine if the playlist changes can be applied to the screen. The checking of start time and end time is an example of a rule that is built into the RUIMS 528 codebase.

An example of a more complex rule is when a set of UI changes occur across more than one screen. This requires RUIMS 522 to correlate that changes were made to more than one screen during, for example the creation of a multivariate test. The playlist entry would contain the screen definitions organized by screen. For RUIMS 528 to manage a rule such as only add UI changes for a screen if that screen is the first screen in a set of screens, ensuring the user doesn't experience one of two screens changing for a multivariate test. RUIMS 528 keeps a stack of the screens visited. So, for example, if the user navigates to Screen 1, to Screen 2, to Screen 3, and back to Screen 2 the stack would contain Screen 1, Screen 2. If a multivariate test were created for Screen 2 and Screen 3 and the user had a new playlist download in the background while the user was on Screen 3 which became live, then in the described implementation when the user navigates back to Screen 2 the user would not see the changes from the newly downloaded multivariate test. Rather, the user would need to navigate back to Screen 1 before the multivariate test would be applied to the user's device.

In certain embodiments, the RUIMS 500 supports the ability to customize a user interface using keys. Keys may include name/value pairs, or just names without associated values. For example, keys can be used to choose resources identified in the ADD and UI controls in a UIDD. In such embodiments, the Application 526 is configured to pass the keys into RUIMS DL 528 and RUIMS RL 916 when accessing a resource or UIDD.

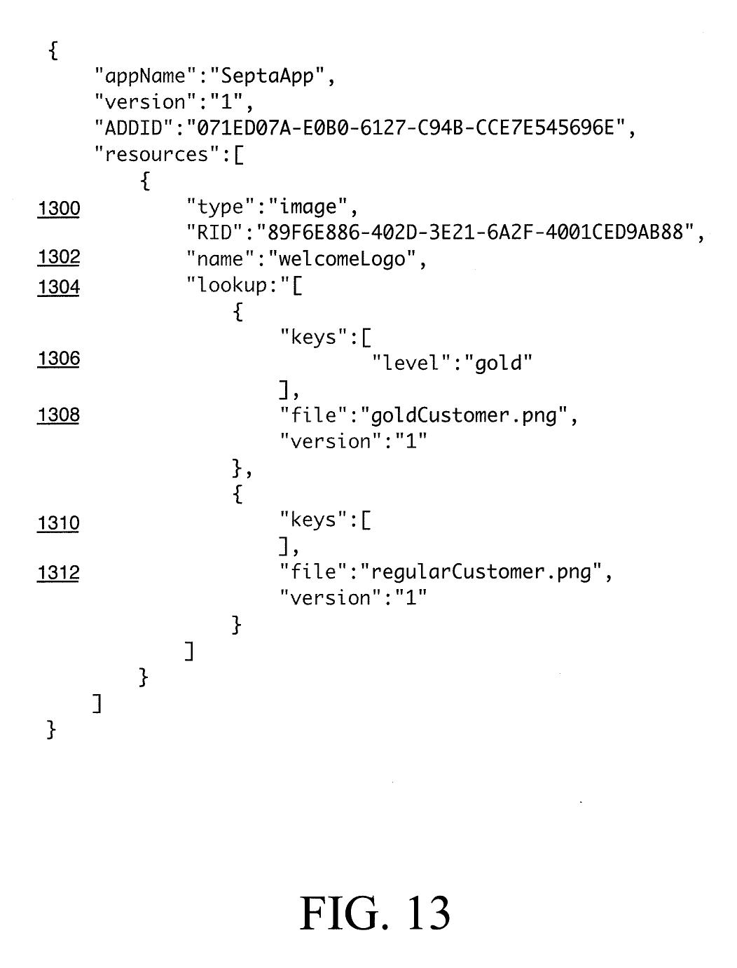

It should be further noted that an ADD can be configured to contain keys on resources used for customization purposes. For example, the exemplary ADD shown in FIG. 13 contains an image named “welcomeLogo” 1302. If in the request for the image resource the key “level” 1306 with a value of “gold” 1306 was requested by the RUIMS DL 528, then the RUIMS will lookup 1304 the correct image file to display given the keys passed in. In this example, the file “goldCustomer.png” 1308 would be returned. The logic to determine which resource is returned based on the keys could be executed in RUIMS DL 528, RUIMS RL 916, or when the resource is retrieved from the local Server Computer 504 or Server Computer 506. If no key match is found, the system may be configured to return a resource associated with no keys or an error if no resource can be found given the current key/value combination.

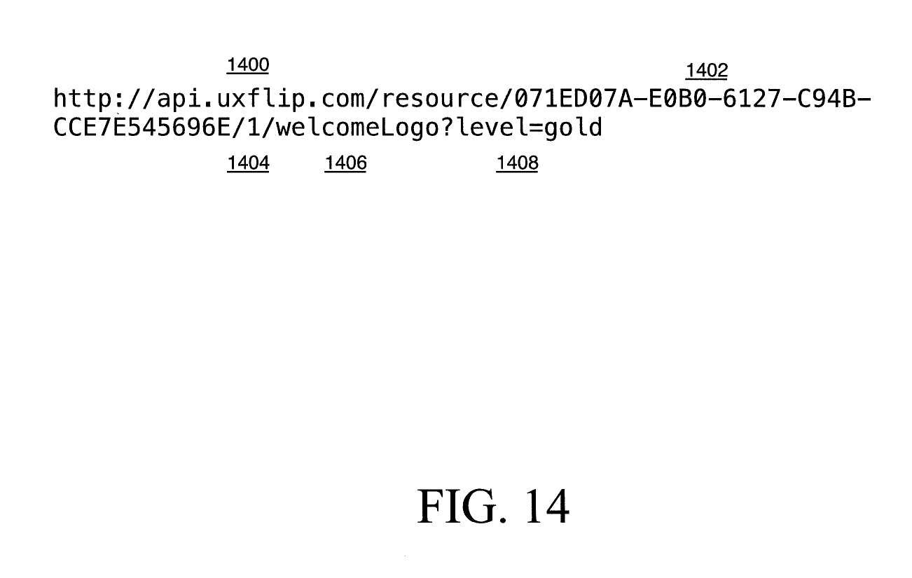

FIG. 14 shows an exemplary HTTP URL requesting the welcomeLogo from the Server Computer 506 during production mode. The exemplary URL contains the server name 1400, the ADDID 1402, the version number 1404, the resource name 1406, and a key named “level” with a key value of “gold” 1408. Keys can also be used to determine which UIDD is returned in an ADD. It should be noted that the URL is for exemplary purposes only, and that the requesting of a resource may be performed using HTTP or any other suitable networking protocol.

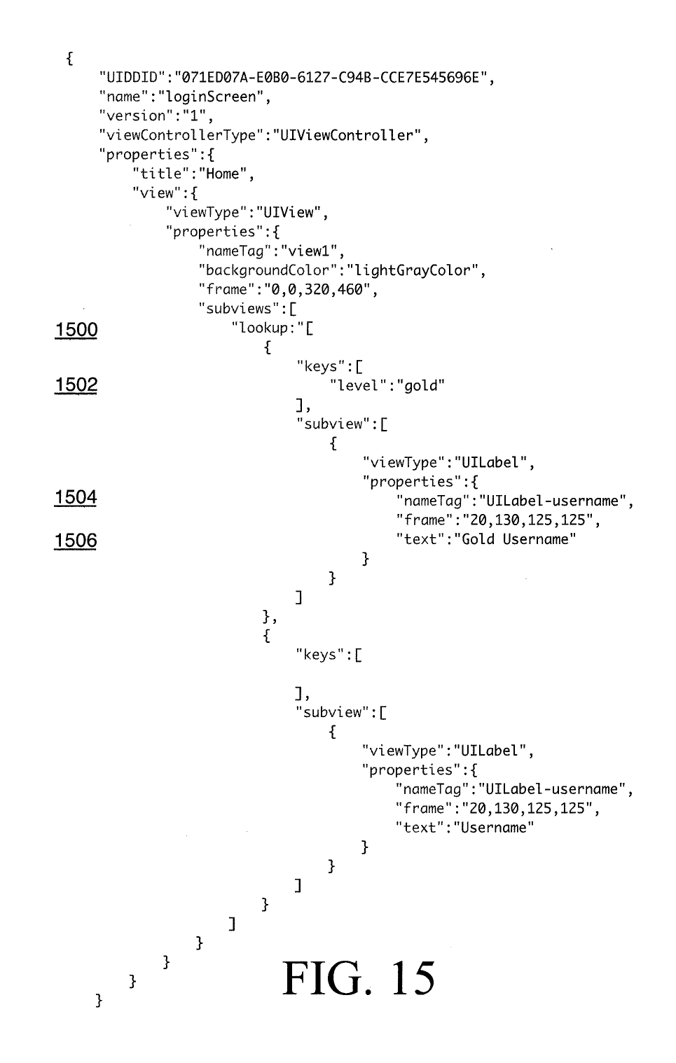

A UIDD can contain keys associated with the definition of the user interface. The keys can be used to choose areas of the UIDD. FIG. 15 shows an exemplary UIDD containing two definitions for the UILabel with the nametag “UILabel-username” 1504. If in the request for the UIDD the key “level” 1502 and a value of “gold” 1502 was requested by the RUIMS DL 528 or RUIMS RL 916, RUIMS will lookup 1500 the correct UILabel-username definition to display given the keys passed in. In this example, the UILabel with the text “Gold Username” 1506 would be returned. The logic to determine which user interface controls are returned based on the keys can be executed in the RUIMS DL 528, RUIMS RL 916, or when the UIDD is retrieved from the local Server Computer 504 or Server Computer 506. If no key match is found, the system may be configured to return the UIDD with no keys or an error if no UIDD can be found given the current key/value combination.

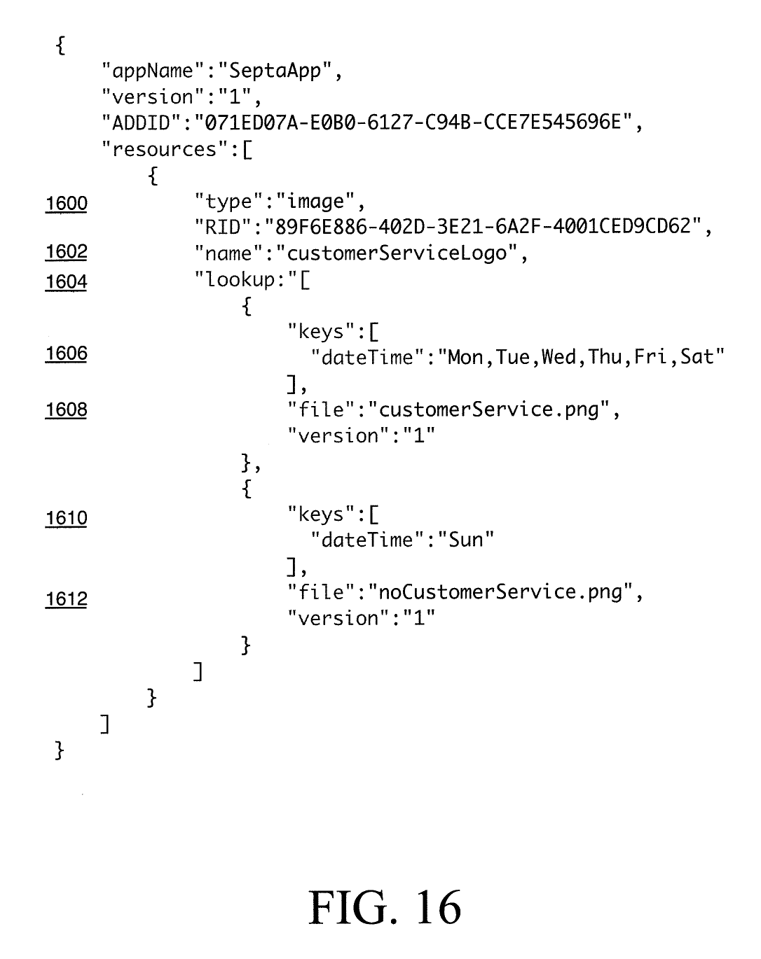

It should be further noted that the ADD, the UIDD, and the resources can be provided with attributes defining caching requirements as well as date and time ranges for when the item is active. For example, a contact customer service button may only be available between the hours of 8:00 am and 5:00 pm EST. If the time were outside of this range the button would not appear. Another example would be replacing all header images with a different set of images between 12:01 am and 11:59 pm local time on Sundays. As part of this description the data and time functionality will be described as a key/value pair but could be implemented independently of the key/value concept. For example, in FIG. 16, the “customerServiceLogo” 1602 has two images defined in the lookup, as shown at 1604. RUIMS 522 has the ability to associate logic with a key and its value. The code is configured as part of the RUIMS 522 system and is used to determine a true or false state. In this example, RUIMS has code associated with the dateTime key running in RUIMS 522 and runs the logic associated with the dateTime value to determine a true or false state. In accordance with this example, if the current day is Monday through Saturday, the resource customerService.png will be used as shown at 1608; however, if the current day is Sunday the resource noCustomerService will be used, as shown at 1612.

When the application has been completed and is ready for production deployment, the ADD, UIDD, and supporting resources can be packaged together (e.g., in a zip file) for bundling with the application. Bundling the initial starting point reduces the amount of data to be downloaded the first time the application is loaded and executed, thereby speeding up the initial load and run time of the application. This is an optional process and is not required. Depending upon the platform (iOS, Android, Windows Phone 7) the bundling process and inclusion into the application may require different steps and processes.

As a performance optimization the ADD and/or UIDDs can be compiled into native code (e.g., Objective-C for iOS) or platform-specific serialization for the Client Device 508.

The RUIMS DL 528 is responsible for managing all resources and UIDDs locally for the Application 526. This is accomplished by holding a local cache of all resources and UIDDs configured as cacheable. Any request for a resource or UIDD first checks the cache and if not available from the cache retrieves the content from RUIMS 522. A resource or UIDD can be requested using keys to further customize the user experience. The RUIMS DL 528 determines whether the customization of the user interface is done in the RUIMS DL or on the local Server Computer 504 or Server Computer 506.

It will be appreciated that, the RUIMS system 500 has the ability to control what developers have and don't have access to through the use of permissions associated with each developer's RUIMS user account. An example of a permission system that can be used in accordance with the present invention is the use of Access Control Lists (ACLs). Access can be granted to or limited by developer accounts and/or groups containing developer accounts. ACLs may be used to protect the reading and writing of ADDs, UIDDs, and resources.

One well-known and powerful feature in the World Wide Web context is A/B or multivariate testing with respect to web pages. This process enables the developer to make one or more changes to an HTML page to test which change or changes cause users to do something more often, which is typically quantified as a “conversion rate.” For Web-based applications the developer typically uses A/B or multivariate testing software to make a client-side change in JavaScript or a server-side change for the testing service to choose which page version to display to a particular user. The server collects metrics and reports back to the developer which variation conversion rate.

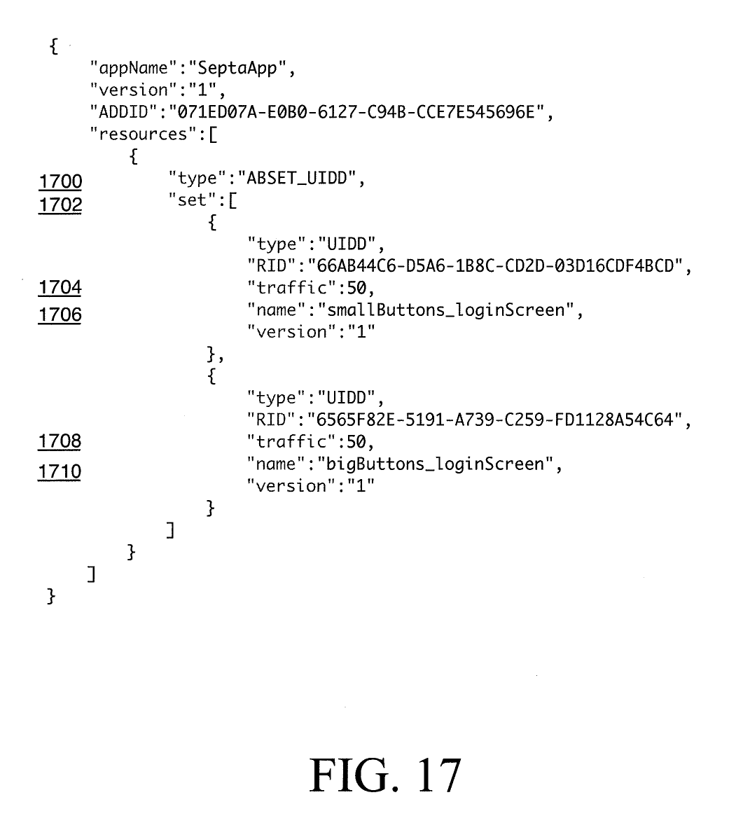

In accordance with the present invention, a developer can use the RUIMS system to create an A/B or multivariate test in the ADD, as shown in FIG. 17. A set 1702 of alternative UIDDs (corresponding to the different user interfaces to be tested) are defined such that the percentage of traffic 1704 allocated to each UIDD will equal 100%. The name 1706 of the referenced UIDD to be displayed by the application appears for each UIDD reference in the set 1702. In this example, 50% of the traffic will receive user interface page 1706 “smallButtonsloginScreen” and 50% of the traffic will alternatively receive user interface page 1710 “bigButtonsloginScreen” in accordance with a “traffic” parameter set forth in the ADD, as shown in FIG. 17, and suitable logic at the Server Computer 506, or elsewhere, for distributing versions for the multivariate test consistent with the traffic parameters specified in the ADD. The UIDD in FIG. 17 is for demonstration purposes only and implementations may contain other properties or have a different document structure.

The RUIMS system 500 has the ability to inject the capturing of analytics into any user interface screen because the RUIMS DL 528 has control over the building of the user interface. Analytics can be automatically added to certain UI controls such as the clicking of buttons or selection of menu items. During operations such as A/B testing these analytics can be used to determine which of two scenarios achieved the desired goal, as discussed in further detail below.

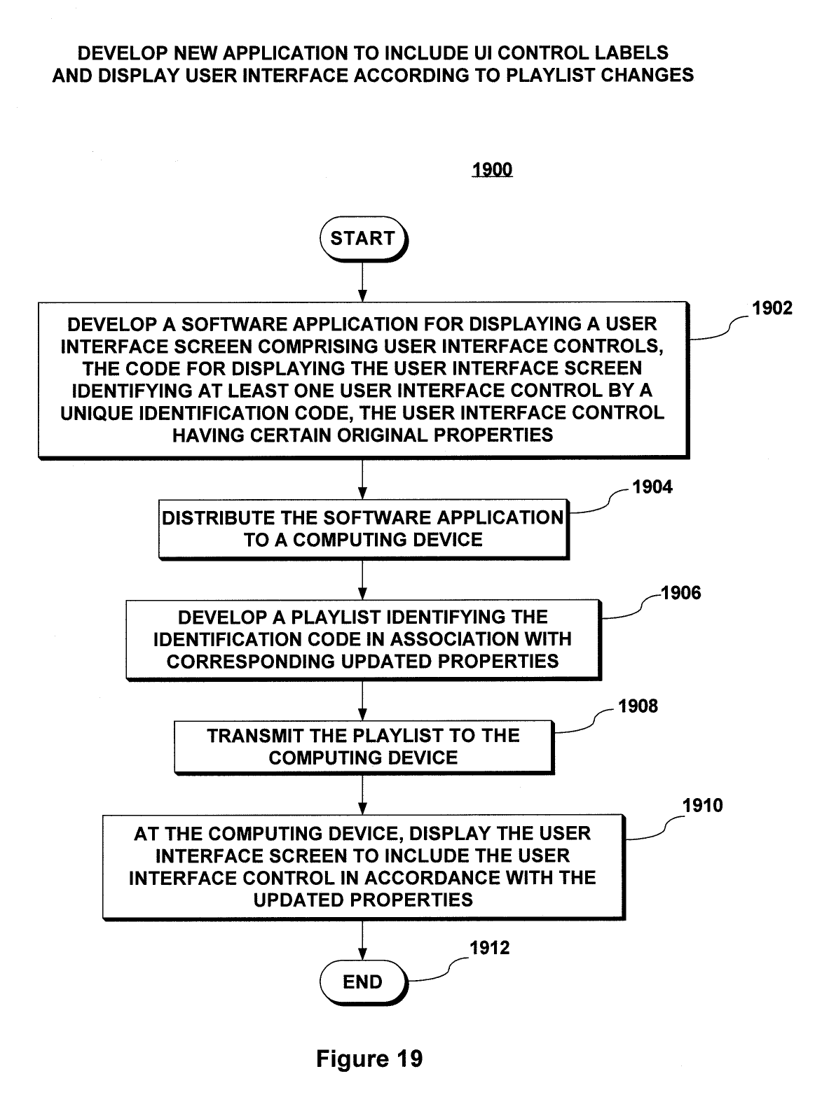

For further illustrative purposes, exemplary operation of the RUIMS system 500 described above is discussed below with reference to FIGS. 19-21. FIG. 19 is a flow diagram 1900 of an exemplary method for runtime user interface management involving developing a software application and displaying the application's user interface in accordance with updated properties contained in a playlist. Accordingly, FIG. 19 illustrates how a software application may be developed in accordance with the teachings of the present invention to include a unique identification code that is associated with each user interface control, and how a separate playlist may then be used to identify changes to the various controls, such that a modified user interface may be displayed during the running of the software application, not in accordance with the application's original code, but rather in accordance with a separate and distinct playlist identifying changes to the user interface defined by the original software application. Accordingly, changes to a software application's user interface may be made during runtime, by applying changes identified in the playlist for user interface controls identified by an associated identification code. Referring now to FIG. 19, the method of the exemplary flow diagram 1900 beings with developing of a software application for displaying a user interface screen comprising user interface controls, as shown at step 1902. The software application may be configured to run in any suitable operating system environment, but by way of non-limiting example, may be configured to run on a mobile telephone computing device in an iOS or Android operating system environment. As will be understood by those skilled in the art, user interface controls include essentially every aspect of a graphical user interface. Each user interface control (e.g., a displayable user-selectable button), has properties associated with it in corresponding software code. The term properties is used herein in a broad and non-limiting fashion to include all associated parameters, properties, values, attributes, etc. of the sort typically contained in software code in association with a user interface control element. By way of example with reference to the exemplary button, such properties may include information relating to the button size, placement/position on a user interface screen, associated text, text color, background color, etc. By way of example for illustrative clarity, the user interface controls and their associated properties as originally hard coded into or otherwise provided as part of the original software application (e.g., in a UIDD or otherwise) are referred to herein as “original” controls and “original” properties. In accordance with the present invention and in this exemplary embodiment, the software application includes software code for displaying a user interface screen that identifies at least one user interface control by a unique identification code. As discussed above the identification code may be a nameTag string (see e.g., 708, FIG. 7 and FIG. 8, showing that each subview has a UI control, each with a viewType and a nameTag) associated with the user interface control that has an identification purpose separate and apart from any conventional user interface control name, property, etc. typically used in conventional programming techniques. Most programming languages provide a tag-like attribute or property that may be used to reference a UI control. In accordance with the present invention, the existing tag field (or an added tag field) is used in a novel fashion to store a unique identification code that is used to bind the UI control to property changes set forth in a playlist. In accordance with the present invention, the unique identification code is assigned to be unique, and the codes are assigned in a deterministic manner.

The exemplary method of FIG. 19 next involves distribution of the software application to a computing device, as shown at step 1904. This may be performed in any suitable conventional manner. By way of example, this may involve distribution of native mobile software applications to mobile computing devices via the Apple AppStore or a similar distribution channel. Alternatively, the application may be otherwise transmitted via a communications network to a computing device, or may be distributed as stored data on a physical computer readable medium.

Next, the exemplary method involves development of changes to the user interface by way of a playlist identifying changes to the original controls and/or properties. In accordance with the present invention, the playlist identifies an identification code corresponding to, e.g., identical to, one of the identification codes contained in the application. In association with the identification code in the playlist, the playlist may include updated properties—i.e., new or changes properties that are different from the original properties associated with the same control identified by the identification code. Accordingly, the playlist can be used to redefine a user interface control of the software application by identifying the user interface control by its identification code and providing associated updated properties to be used in addition to and/or instead of the original properties. By way of example, the playlist may have the form of an XML document, a JSON document, an Apple plist, etc. An exemplary playlist is provided in FIG. 19. It should be appreciated that the playlist may not only include changes to an existing control, but may also provide for removing/hiding controls and/or adding entirely new controls. Further, it should be appreciated that a single playlist may address multiple changes to multiple controls. Further, a playlist may include a plurality of individual playlists, e.g., one of each user interface screen. In this case, the individual playlists may be referred to herein as playlist entries, but the term “playlist” is used broadly herein to include playlists and playlists of playlist entries.

Next, the playlist is transmitted to the computing device, as shown at step 1808. This may be performed in any suitable fashion. By way of example, such transmission may occur via a communications network, and may be initiated by the client computing device 508, e.g., under control of the RUIMS DL 528, e.g., as part of general housekeeping matters to update an application, or responsive to executing of an application, or just prior to display of a user interface screen during running of an application, as described above in greater detail.

The exemplary method next involves the computing device, e.g. 508, displaying the user interface screen during execution of the application to include the user interface control(s) in accordance with the updated properties provided in the playlist, as shown at 1910, and the method ends, at shown at 1912. As described above, such functionality may be provided by the software application 526 in cooperation the RUIMS DL 528.

Accordingly, information from the subsequently-distributed playlist effectively supersedes (e.g., by replacing or removing) and/or supplements any corresponding code hard coded or otherwise provided as part of the software application (including in any UIDD) previously distributed to the computing device. This allows the software application to be modified after distribution, e.g., after downloading from an App store or the like, and more specifically, during application runtime. Further still, to the extent that the software application is configured to request the playlist automatedly, without user involvement, the software application may thus be revised/updated to include user interface changes in a manner transparent to the user, without the need for the user to download a new version of the application. Accordingly, changes to the user interface/software application can be effectively “pushed” to the user, and the user is not required to initiate any “updating” process in a “pull” mode of operation. This provides for centralized control, e.g., to a marketing executive, over the user interfaces displayed by software applications on a plurality of individual user's computing devices that otherwise would generally be outside of the marketing executive's control.

It should be noted that in certain embodiments, a software application may be built to be compliant with the teachings of the present invention, e.g., to include a unique identification code in the software application as part of initial programming. However, the teachings of the present invention also provide for the processing of “legacy” software applications that were not originally programmed in accordance with the teachings of the present invention. With respect to such existing “legacy” software applications, the original source code may be recompiled or otherwise integrated with an SDK in accordance with the present invention, and then may be redistributed, e.g., through an app store, to client computing devices. The SDK (e.g., RUIMS 522) is configured to process an in-memory view hierarchy of a user interface screen, to effectively reverse engineer the view hierarchy by converting the view hierarchy details into a document (e.g., as a JSON or XML document) and communicating the document to RUIMS 522 at Server Computer 506, which may then communicate the information to UI Management Device 502. This document is essentially a UIDD. Such an in-memory view hierarchy is routinely created during runtime of conventional software applications. During such processing, the SDK assigns a unique identification code to each of the user interface controls of the view hierarchy. For example, this may be performed at client computing device 508 by RUIMS DL 528 in a programmatic fashion, automatedly before each corresponding user interface screen is displayed by the client computing device 508, and before changes from a playlist are applied.

It should be further noted that in certain embodiments, a new user interface screen for the software application may be built by using the teachings of the present invention. In one such exemplary embodiment, the software application does not include code for displaying user interface controls of the new user interface screen. In this case, the application may include a reference to a new “blank” UIDD for the new user interface screen. The new “blank” UIDD may be stored at the Server Computer 506. Accordingly, rather than reverse engineering of an existing user interface screen as described above, selection of and/or navigation to the reference to the “blank” user interface screen at the client computing device will result in messaging from RUIMS 528 to RUIMS 522 at Server Computer 506 that will result in a blank UIDD being sent from the Server Computer 506 to the user interface management device 502, which will in turn permit “editing” of the list of controls of the UIDD to add new controls and associated properties, and thus to build the new user interface screen.

Accordingly, as illustrated by this embodiment, the RUIMS system is capable of provide centralized control of user interfaces displayed by disparately-owned and operated computing devices in connection with not only newly-created software applications, but also pre-existing, legacy software applications.

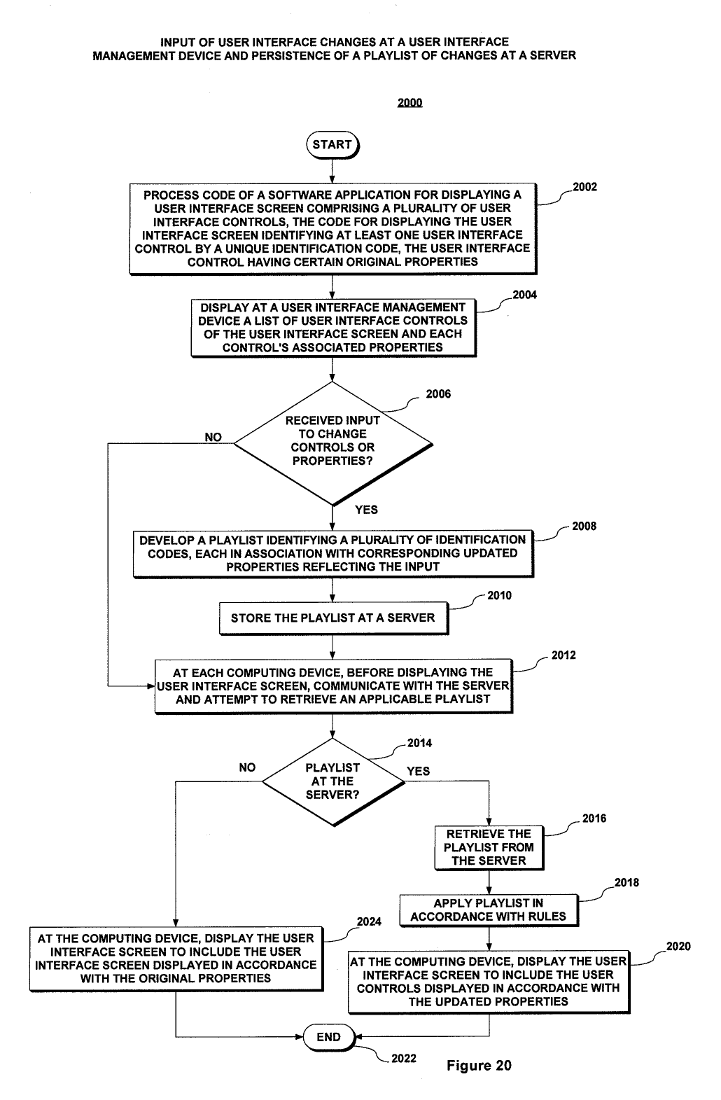

FIG. 20 is a flow diagram 2000 of another exemplary method for runtime user interface management involving developing a software application, developing a playlist of changes at a user interface management device, and displaying the application's user interface in accordance with updated properties contained in the playlist. This exemplary method beings with processing of code of a software application for displaying a user interface screen comprising a plurality of user interface controls, as shown at 2002. The code includes a plurality of user interface controls, each of which is identified by a respective unique identification code and has associated original properties. It should be noted that this may be the result of original programming of the software application in accordance with the present invention, as described with respect to FIG. 19, or as the result of processing of a legacy software application to provide such identification codes. In this step, however, the code is processed to identify each user interface control and each control's associated identification code and properties. Accordingly, for example, such processing may identify a nameTag storing a unique identification code of the type shown in the example of FIG. 8. Preferably, this processing is performed by the SDK (RUIMS 528) compiled or otherwise integrated with the software application 526 resident at the client computing device 508.

Next, the method involves displaying a list of the user interface controls of the user interface screen and each control's associated properties, as shown at 2004. Preferably, this step is done at a user interface management device 502, as shown in FIG. 5. This step may be performed after associated data is transmitted from the server 506 (specifically, from RUIMS 522, FIG. 5) to the user interface management device (specifically, to RUIMS 514, FIG. 5). By way of example, a display window displayable via the user interface management device 502 is shown in FIG. 10 displaying the following list of user interface controls “IULabel”, “UIText Field”, “UILabel”, “UITextField”, “UIButton”. Further, for the first UILabel control, this window of FIG. 10 displays the corresponding unique identification code A25E0D87-1DD4-A030-54FB-B1198F5, and associated properties including frame=20, 130, 125, 125, textColor=blackColor, and backgroundColor=clearColor.

In this exemplary embodiment, the method next involves determining whether input has been received to change the list of controls (e.g., to add or delete controls) or associated properties of one of the existing controls, as shown at 2006. This input is provided by the user, and preferably received at the user interface management device 502. The RUIMS 514 of device 502 determines whether such input has been provided.

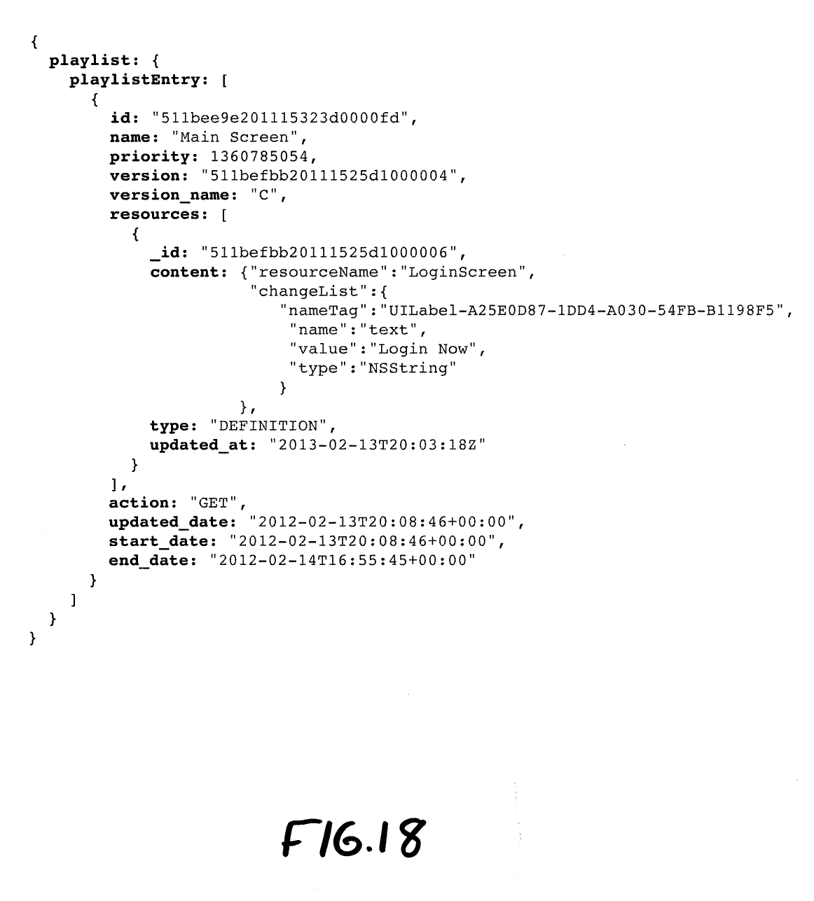

If it is determined at 2006 that such input has been provided, the RUIMS 514 develops a playlist reflecting the input, as shown at 2008. For example, the playlist may identify (i) each identification code of each new/deleted/changed user interface control, and (ii) the corresponding updated properties for each identification code. The playlist is preferably a document created by RUIMS 514, an example of which is shown in FIG. 18.

This exemplary method next involves storing the playlist at a server, e.g., Server Computer 506, as shown at 2010. This may be performed by RUIMS 514 transmitting a message communicating such changes to RUIMS 522 of Server Computer 506, e.g., via messaging server 530. The playlist may be stored in the server's data store 540, as shown in FIG. 5. Accordingly, changes made by a single user at a single user interface management device 502 may be persisted in a network-accessible server for distribution to various computing devices. Notably, the playlist may be stored at the server as a playlist of changes to an existing UIDD or user interface screen, or may be stored by simply updating the UIDD version at the server, at which point the updated UIDD is effectively the playlist.

It should be noted that at this point the software application may be running asynchronously on various different computing devices. As shown at 2012, before one of the instances of the application displays the user interface screen, the associated computing device communicates with the server, e.g., Server Computer 506, and attempts to retrieve an applicable playlist. In other words, the application checks to see if a playlist is available. This may be performed by RUIMS DL 528 at the client device 508. Notably, the process flow may proceed to this step from step 2006 if no input was received.

If it is determined at 2014 that an applicable playlist is stored at the server, then the playlist is transmitted from the server, e.g., 506 to the client device, e.g., 508, as shown at 2016. This may be performed by under the control of one or more of RUIMS 528 and 522.

After receipt of the playlist at the client device 508, the changes from the playlist are applied in accordance with rules, as shown at 2018. This may be performed by RUIMS 528 at that client device 508. By way of example and as described above, the rules may provide that the playlist, or only certain portions of the playlist should be applied as a function of certain business logic, a geographical location, a device type, etc., and/or that they may be applied only at a certain point in time, e.g., only after restarting of the application, only after a certain point in a flow of the application, etc.

After application of the playlist, the computing device displays the user interface screen to include the user interface controls as displayed in accordance with the updated properties from the playlist, as shown at 2020, and the method ends as shown at 2022.

If, however, it is determined at 2014 that an applicable playlist is not stored at the server, then the computing device displays the user interface screen to include the user interface controls as displayed in accordance with the original properties, as shown at 2024, and the method ends as shown at 2022.

Notably, other instances of the software application running on other computing devices may asynchronously contact the server to check for playlists and apply them as appropriate, and this may continue until the playlist is deleted or updated. Accordingly, updates to the interface may be distributed to many users of the software application according to a “push” model, from the perspective of the marketer/distributor of the software application, though it is noted that technologically the software application including the RUIMS DL is constructed consistent with the teachings of the present invention to poll, or pull, changes/updates from the server, but without the need for an affirmative act by the user of the client computing devices.

FIG. 21 is a flow diagram 2100 of an exemplary method for runtime user interface management in the context of multivariate user interface testing in accordance with an exemplary embodiment of the present invention. This exemplary method involves developing a software application and selectively displaying the application's user interface in accordance with updated properties contained in one or more playlists (or playlist entries) to provide multiple versions of a user interface screen.

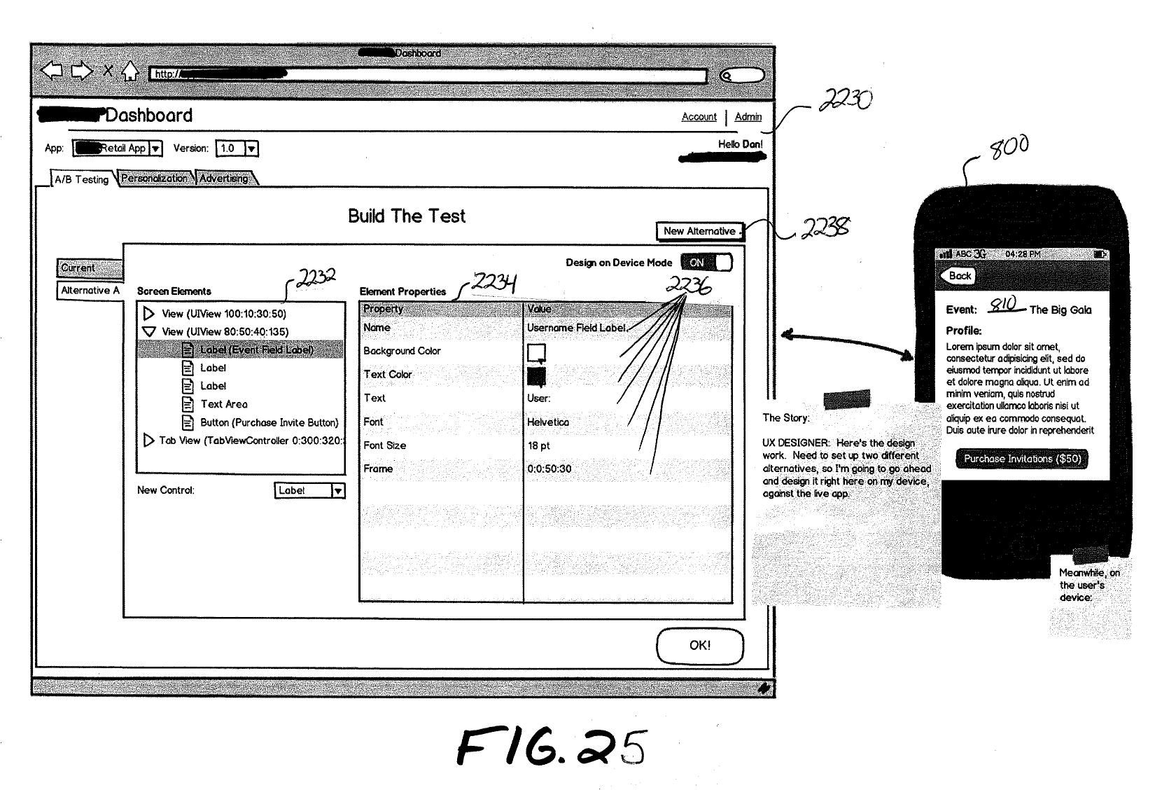

Referring now to FIG. 21, this exemplary method begins with display at a user interface management device, e.g., 502, a list of user interface controls of a software application's user interface screen, as shown at 2102. Accordingly, this step is similar to step 2004 described above with reference to FIG. 20 and FIG. 10. FIG. 25 shows another example of a window 2230 displaying such a list.

Next, the system involves receipt of input to change the list of controls and/or properties of one or more of the UI controls, as shown at 2104. Accordingly, this step is somewhat similar to step 5006 described above with reference to FIG. 20. Preferably, this input is received by RUIMS 514.

Accordingly, a playlist identifying the changes is created, e.g., as described above with reference to 2008 of FIG. 20.

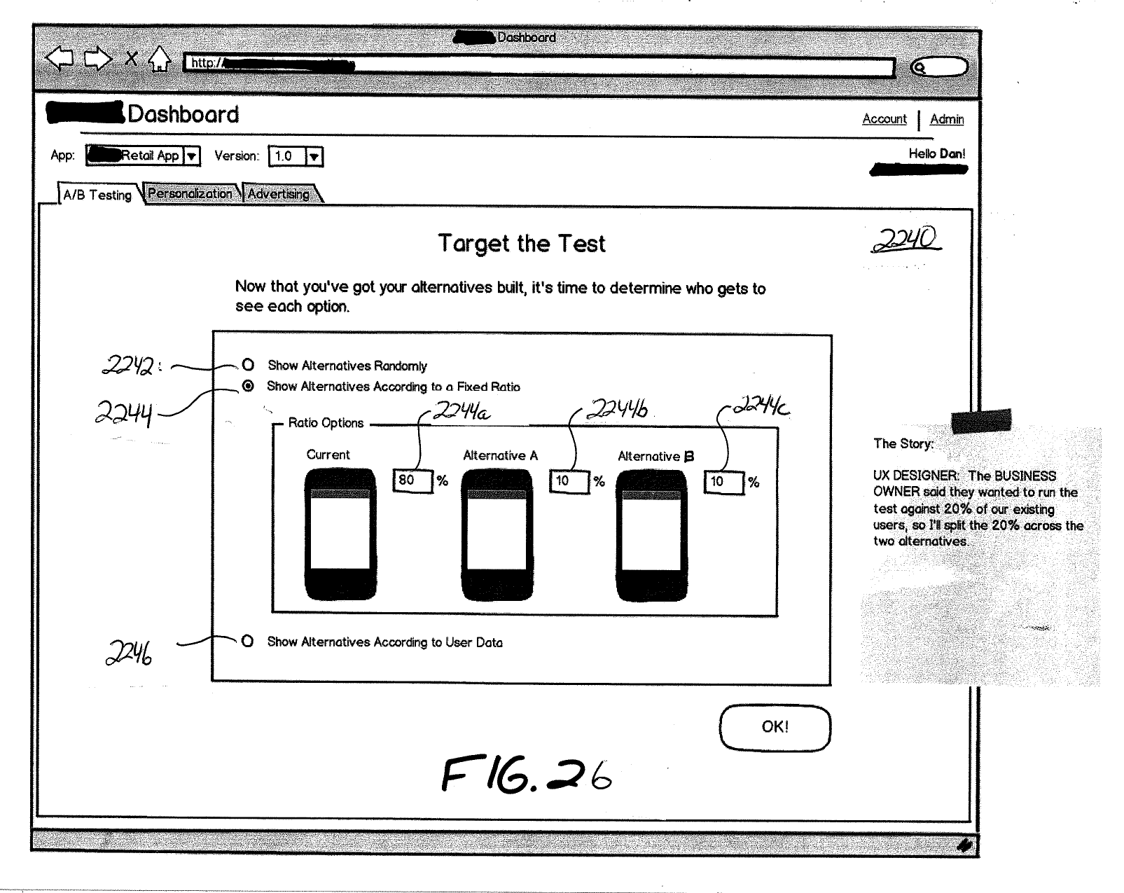

In this embodiment, the user interface management device 502 also receives user input defining a distribution rule for different versions of the interface screen, as shown at 2008. By way of example, the rule may provide for distribution of the playlist only 50% of the time, so that a first half of the software applications will not receive a playlist and will display the user interface screen in accordance with the original properties, and that the other of the software supplications will receive the playlist and thus will display the user interface screen in accordance with the updated properties contained in the playlist. It should be appreciate that the rules may include not only proportions and/or ratios, but may also include other logic. For example, such other logic may relate to distribution of the playlist as a function of geographic location data, user information, device type, etc. It should further be noted that a larger number of versions may be supported concurrently. FIG. 26 shows an exemplary window 2240 displayable at a user interface management device for receiving user input for defining a distribution rule. In the example shown, the rule provides for distribution of the “current” version 80% of the time, the playlist corresponding to Alternative A 10% of the time, and the playlist corresponding to Alternative B 10% of the time.

In this embodiment, the playlist is next stored at the server, as shown at 2110. This may occur as described above with reference to 2010 of FIG. 20. The distribution rule data is also communicated to the server, e.g. via messaging between RUIMS 514 and RUIMS 522. In a one embodiment, the distribution rule is included as part of the playlist. In other embodiments, the distribution rule is stored and managed at the Server Computer 506, and a server-side rule provides a version/updates consistent with a version in response to each particular request as a function of the distribution rule and distribution status/history as tracked by the Server Computer 506.

Next, the server receives from a computing device a request attempting to retrieve an applicable playlist. Accordingly, this step is similar to step 2012 of FIG. 20. In this embodiment, the server then determines, as a function of the corresponding distribution rule, whether to distribute the playlist in response to this present request, as shown at 2114. For example, is the rule provides that the playlist should be distributed 50% of the time, then the server may distribute the playlist in alternating fashion, and may determine to distribute the playlist in response to this request only if it did not distribute the playlist in response to the immediately preceding request. Any suitable methodology may be used for making this determination.

If it is determined at 2114 that the playlist should be distributed, then the server transmits the playlist to the computing device, the computing device applies the playlist in accordance with any applicable rules, and then displays the user interface screen to include the user interface controls in accordance with the updated properties contained in the playlist, as shown at 2116-2120, which steps are similar to those described with reference to 2016-2020 of FIG. 20.

If it is determined at 2114 that the playlist should be not distributed, then the server does not transmit the playlist to the computing device, and the computing device displays the user interface screen to include the user interface controls in accordance with the original properties contained in the software application, as shown at 2124, which is similar to 2024 of FIG. 20.

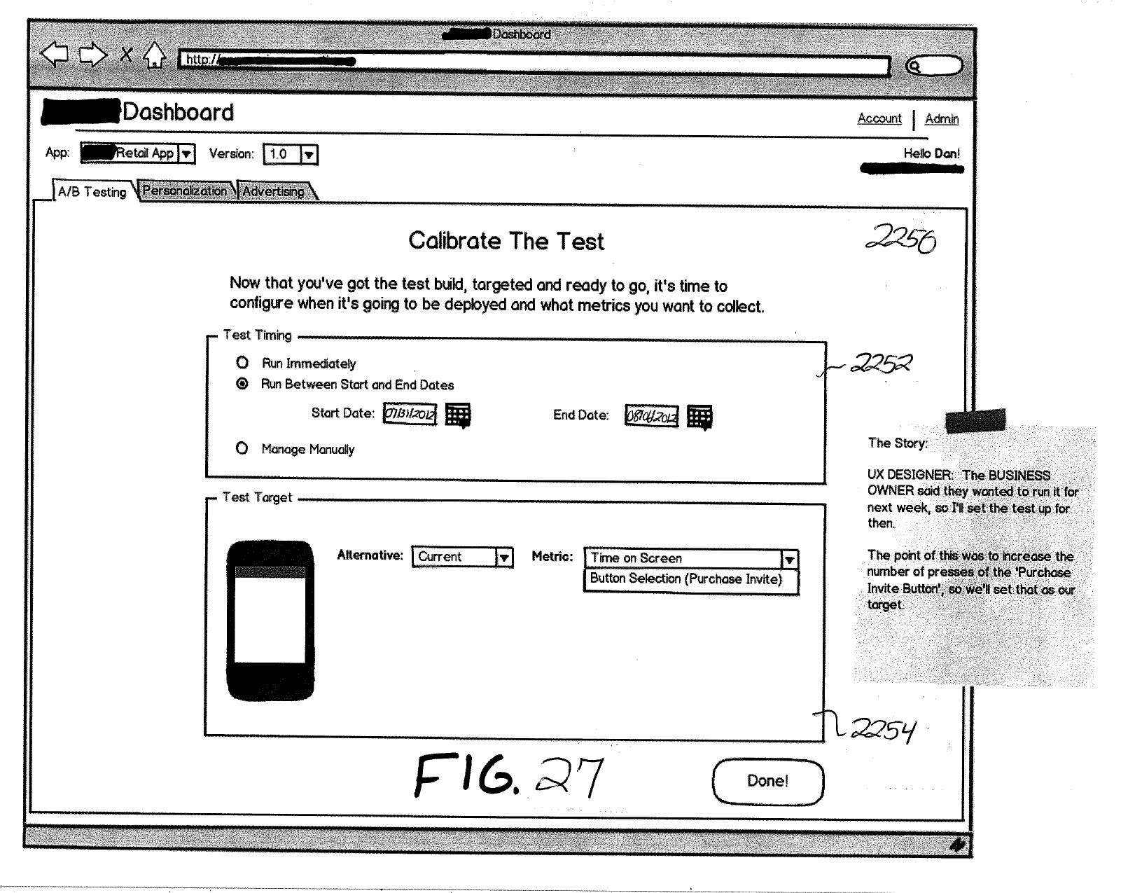

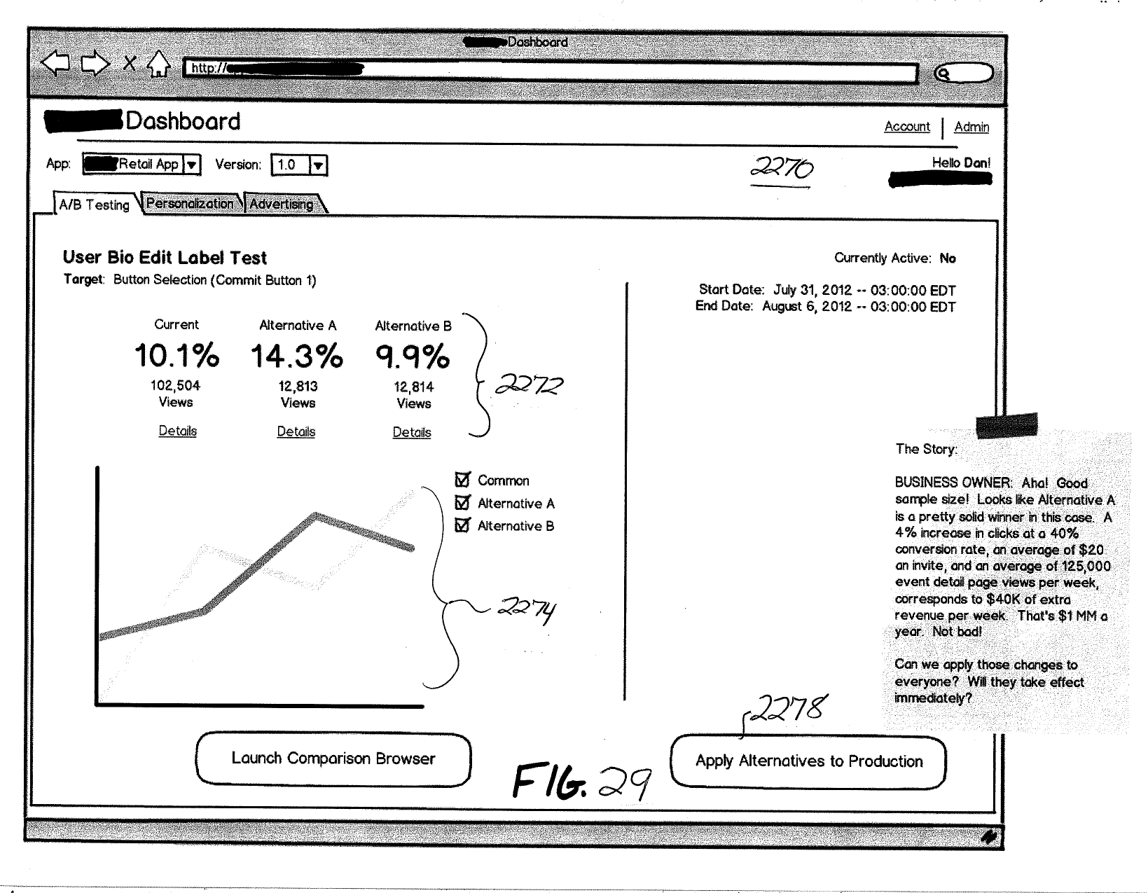

In either case, in this exemplary embodiment, the server is configured to track use of the user interface and report user interface analytics, as shown at 2122. These analytics may include any suitable information, such as, for example, click through rates for user interface buttons displayed on the page. Additional information is provided below. FIG. 27 shows an exemplary user interface window 2250 displayable at a user interface management device for configuring the server to track use of the corresponding user interface. In one embodiment, such user interface analytics are reported via the user interface management device. FIG. 29 shows an exemplary user interface window 2270 for reporting such user interface analytics. Generally, these analytics provide information relating to the relative “performance” of the original and updated versions of the user interface, and it may be determined that one version performs better than another, e.g., produces a higher click-through rate.

In this method, it is then determined whether to change the interface, as shown at 2126. This may be determined by the user or programmatically, e.g., by comparing relative performance as indicated by the analytics. If it is determined to change the user interface, the method flow returns to step 2104 and the method repeats. If it is determined not to change the user interface then it is next determined whether a next request attempting to retrieve the playlist has been received at the server. If so, the server again determines whether to distribute the playlist in response to the request at 2114, and the method repeats. If not, the method ends, as shown at 2130.

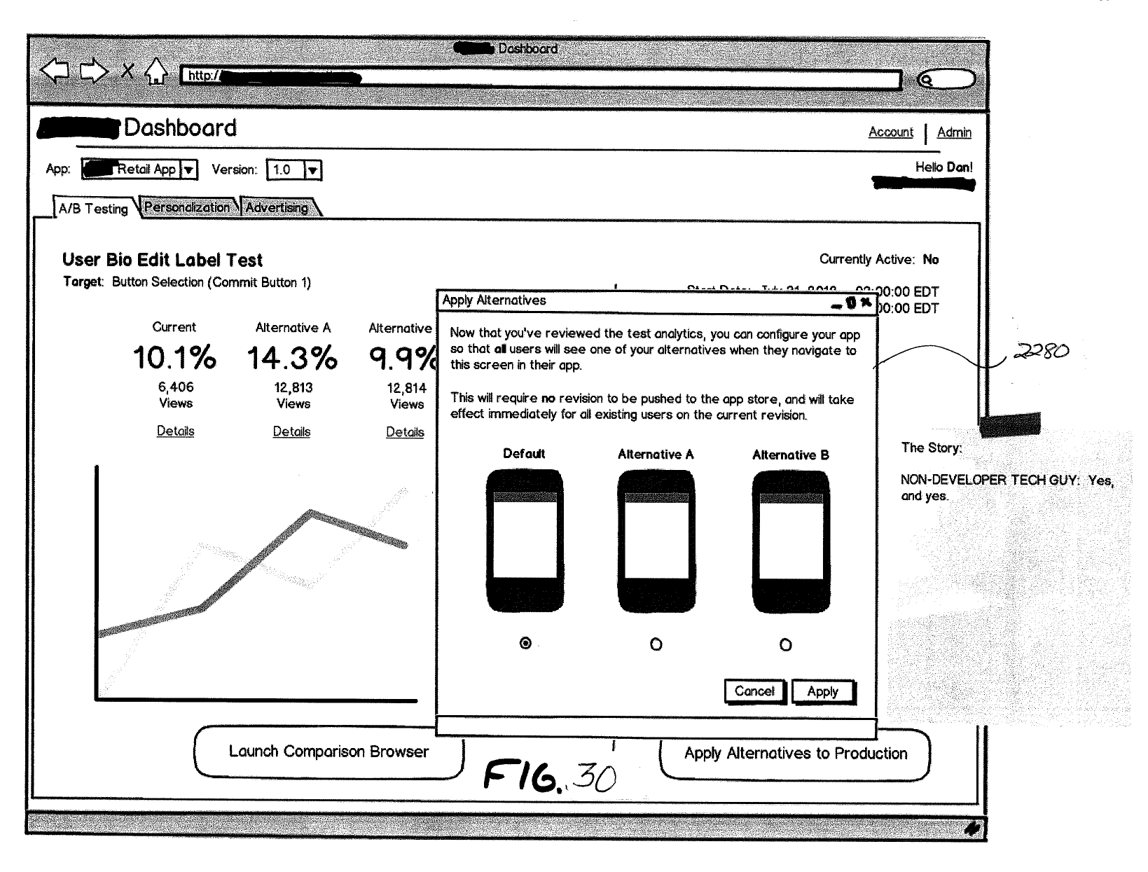

Accordingly, this method may be used to implement multivariate testing to test the performance of multiple versions of a user interface. Notably, after a test a higher-performing version may be adopted as the “universal” version by changing the distribution rules for the various versions, e.g., to set the distribution rule to 100% for the playlist to result in abandonment of the original version and universal adoption of the updated version. For example, this may be performed by selecting the Apply Alternatives to Production button 2278 and selecting a version (Current/Alternative A/Alternative B) to be delivered to users 100% of the time, as shown in the user interface windows 2270, 2280 of FIGS. 29 and 30.

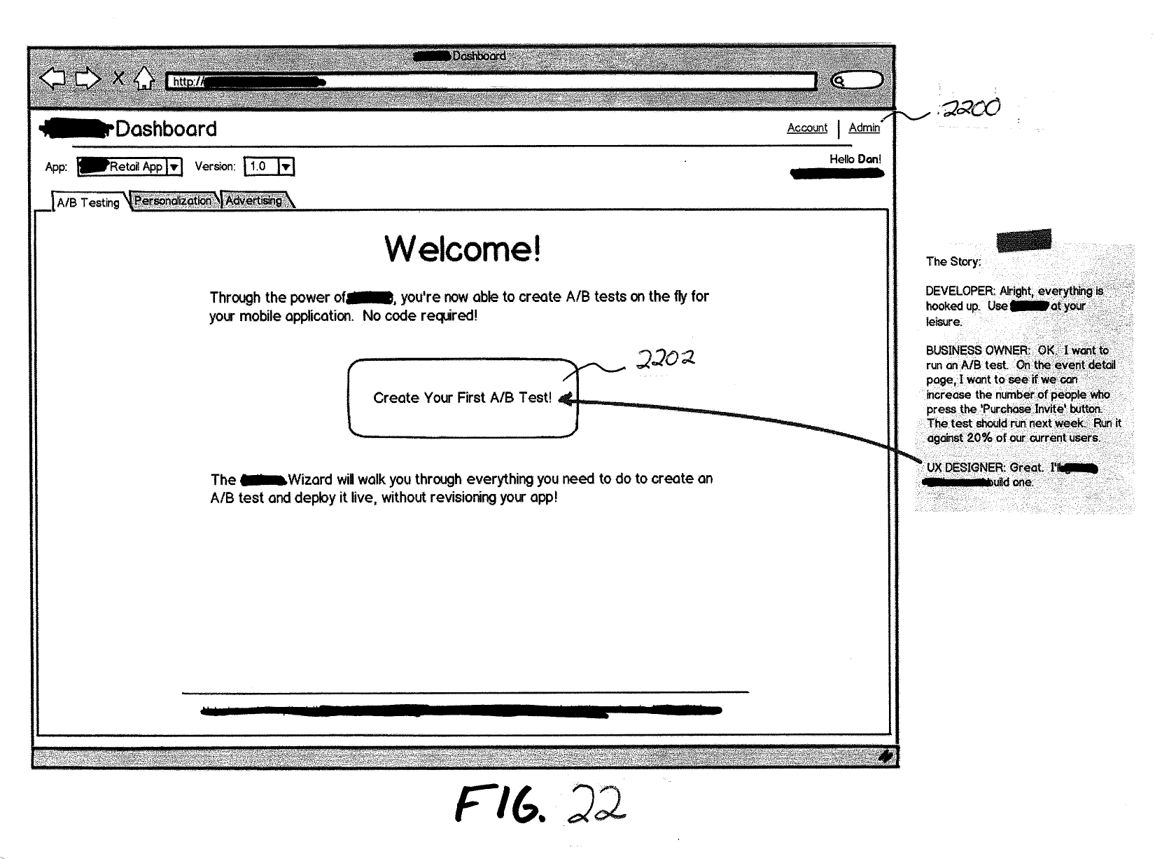

Use of the RUIMS system 500 in the context of A/B (multivariate) testing is discussed in greater detail below with reference to FIGS. 22-30. FIGS. 22-30 are graphical user interface windows of an exemplary “wizard,” illustrating an exemplary use of the RUIMS system to perform A/B testing of alternative user interface windows on mobile computing devices. Referring now to FIG. 22, a developer having a developer account with the RUIMS system may be provided with a username and login for accessing a secure website in a conventional HTTP communications session. The website may provide a series of user-navigable web pages collectively providing the functionality of a “wizard” for use to implement an A/B test using RUIMS. Exemplary user interface windows displayable by such a website are shown in FIGS. 22-30. FIG. 22 shows an exemplary interface window 2200 including a user-selectable button 2202 for initiating an A/B test creation “wizard” process.

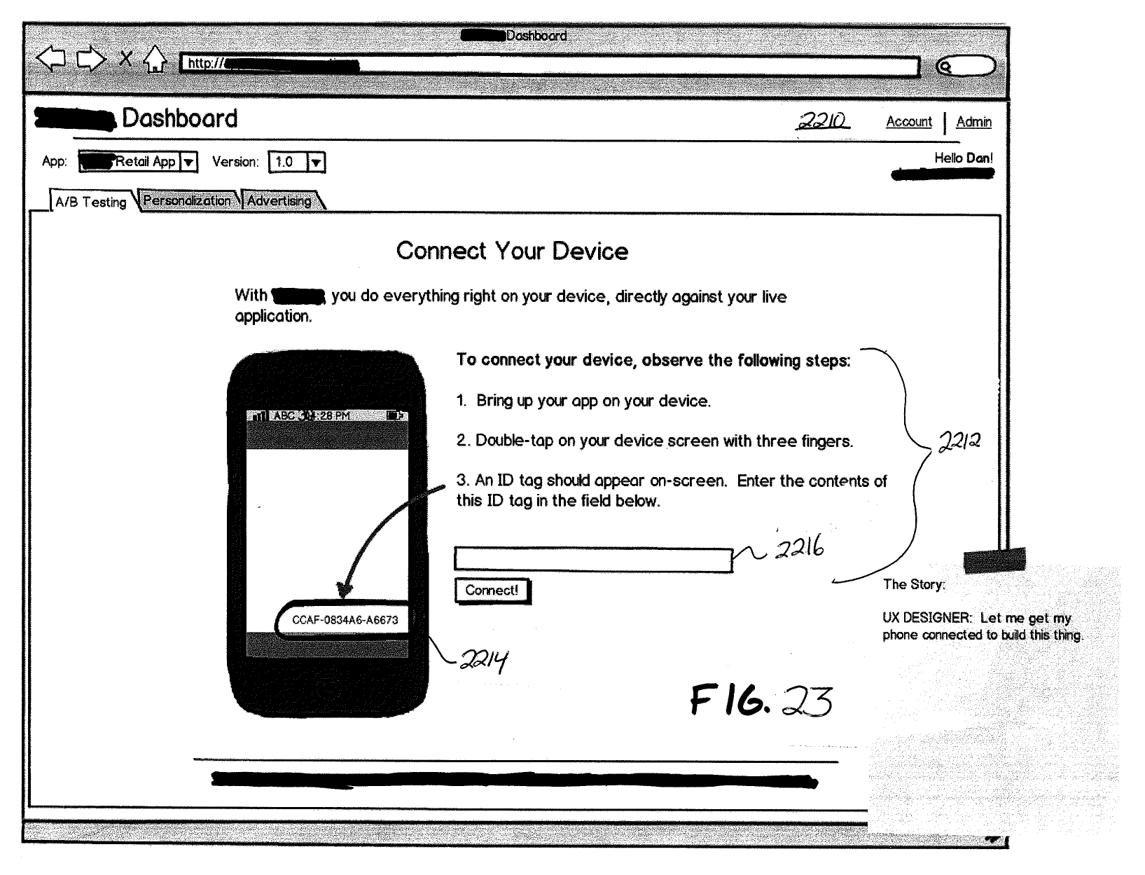

In the illustrative example of FIGS. 22-30, after logging in and selecting the test-creation button 2202, a developer is presented with a device connection interface window 2210, as shown in FIG. 23. The device connection interface window 2210 displays to the developer instructions 2212 for placing the developer's mobile device into a test mode, such that the mobile device and the website may be operated in conjunction to implement the A/B test. In one embodiment, the instructions 2212 comprise instructions for providing gesture input to the mobile device to cause display via the mobile device of a unique access code 2214. In such an embodiment, the instructions 2212 may further include instructions to input the access code into a text entry field 2216 of the device connection interface window 2210, as shown in FIG. 23.

Accordingly, it will be appreciated that to use the RUIMS system 500 to implement an A/B test for a specific mobile device software application, that same software application must first be configured to be compatible with the RUIMS system, so that, for example, it will display such an access code in response to the gesture input. A developer can configure an application for such testing purposes by integrating an RUIMS software development kit (SDK) with source code to build the application during initial coding/application development. Development of SDKs, publishing of SDKs, and integration of SDKs into software applications (e.g., by compiling an associated library (e.g., RUIMS DL 528) into the application) is well-known in the art, and may be performed in a conventional manner, and thus are not discussed in detail herein.

After supplying the access code displayed by the mobile device to the test entry field 1816 of the device connection interface window 2210, and submitting it to the system, the Server Computer 506 authenticates that the develop has a valid account, that the code is valid, etc. for security purposes. Such steps can be performed consistent with well-known authentication techniques, and thus are not discussed in detail herein.

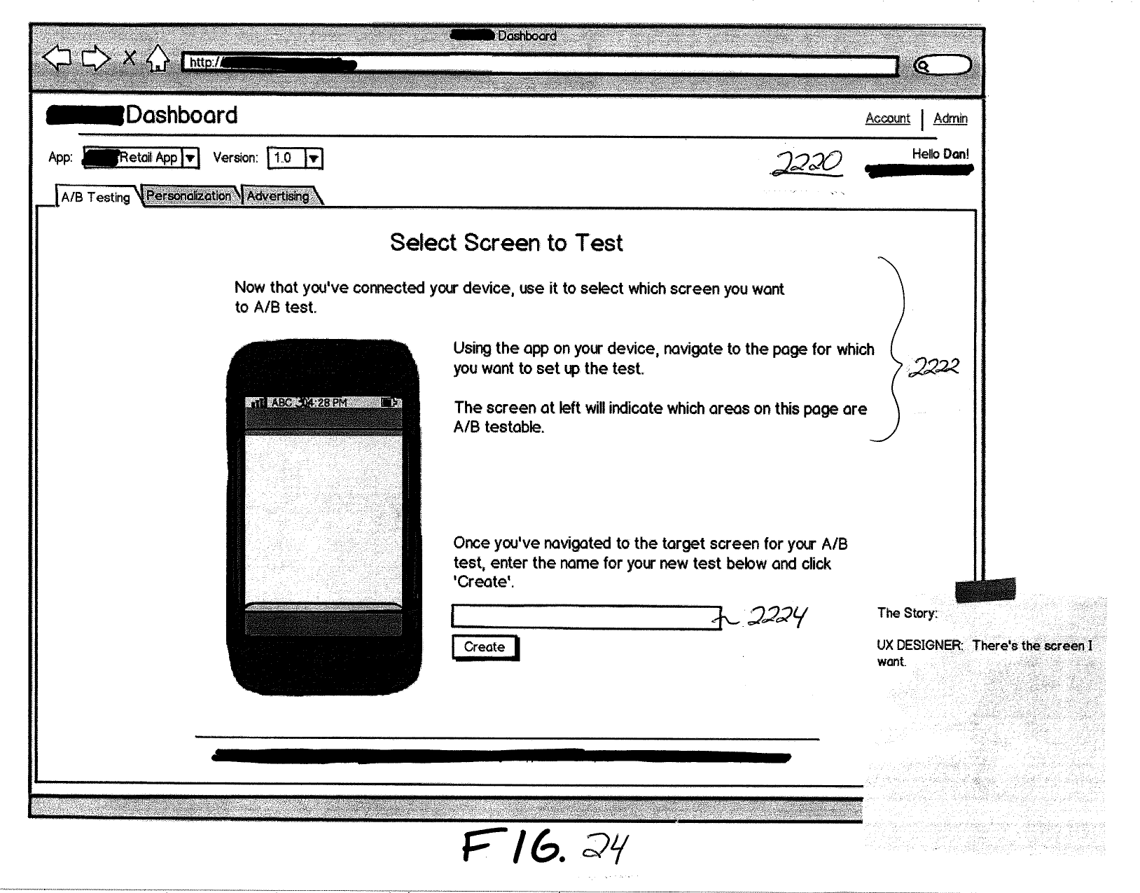

Next, the wizard displays a screen selection interface window 2220, as shown in FIG. 24. This window displays instructions 2222 for prompting the developer to use the developer's mobile device to navigate to the specific application user interface window for which the A/B test is to be performed. Optionally, this window may further include a text entry field 2224 prompting the developer to enter a name for this particular test.

Use of the developer's mobile device 800 to display the user interface window to be tested 810 causes the developer's mobile device to display the actual, final version of the user interface window 810 as presently coded, as shown in FIG. 25. Additionally, such display of the window 810 via the mobile device 800 also causes display of a test-building interface window 1830 via the wizard, as shown in FIG. 25. This window is analogous to the display show in FIG. 10 and described above.

The ability to makes changes to the UI running inside an app requires the ability to reference each UI control by a unique identifier, referred to herein as an identification code. This unique identification code can be used outside of the software application to reference all user interface controls. One example of such an identification code is the use of a nameTag set during the creation of the UI control containing string name.

For screens that were built without RUIMS a different approach is required. The SDK (528) reverse engineers the UI view hierarchy and assigns a deterministic viewId to each control on the screen. An exemplary algorithm includes the traversing of each UI control and assigning a string representation based on a concatenation of UI control type (i.e. label), the depth of the UI control in the hierarchy, and the z-order of the UI control at the current depth. The viewId is then passed back to the server with the control's property details so later changes can be matched back to the originating UI control.

In this exemplary test-building interface window 2230, each control of the user interface window 810 displayed on the mobile device 800 is separately accessible, viewable and/or modifiable, as shown in FIG. 25. Exemplary controls of the user interface window include UI labels, UI text, UI buttons, and their associated properties, such as text, background and text colors, fonts, font sizes, etc. It should be noted that each of these controls and their associated properties are encapsulated and/or reflected in the underlying code for causing display of the user interface window 810. In accordance with the present invention, those controls are displayed in an overt fashion, along with an interface for directly modifying the controls and/or their associated properties. By way of example, the screen controls of user interface window 810 are displayed in a list or tree-form structure in a screen control display window 2232 of window 2230. Further, the control properties are displayed in an control properties display window 2234 for a selected screen control. Further, the control properties display window 2234 includes input fields 2236 for modifying the current control properties. As described in greater detail above, RUIMS 514 sends a message received by RUIMS 522 at Server Computer 506, which in turn communications a corresponding message to RUIMS 528 at Client Device 508. The message effectively asks RUIMS 528 to reverse engineer the screen currently displayed by the Client Device 508. In this instance, RUIMS 528 creates a new UIDD which becomes a blank slate for making changes to the screen/developing a new screen. RUIMS 528 then sends the UIDD to RUIMS 522 and/or Server Computer 506 for persistent storage, and then sends a message through RUIMS 522 and Server 506 to RUIMS 514 at UI Management Device 502, to confirm that the process of reverse engineering is complete. It will be appreciated that the UIDD is the current state of the screen including any permanent changes may be previous A/B tests. Accordingly, it will be appreciated that this interface window allows a developer to directly manipulate each control through a graphical user interface, without having to write additional code. The necessary code for implementing the changes specific through user interface window 1830 are generated programmatically in accordance with the present invention.

Further, consistent with the description above in relation to the RUIMS system, input entered into the input fields 2236 will immediately cause corresponding changes to the interface window 810 displayed via the mobile computing device 800, due to the messaging and version-control system of the RUIMS system described above.

Changes to the interface window 810 may be entered and re-entered to define an alternative user interface display window for testing purposes. In this example, it is contemplated that there is a current/original interface window (“Current”) and a newly-designed alternative user interface window (“Alternative A”) that reflects the changes entered via window 2230. Notably, additional alternative interface windows (e.g., “Alternative B”) may be designed and saved for testing purposes, e.g., using “New Alternative” button 2238 and similar input windows/fields.

Referring now FIG. 26, a test targeting interface window 2240 is shown. In this window, the developer is presented with user-selectable options for configuring the test to deliver the user interface windows to be tested. Preferably, as the user navigates through the Application, each interaction with the user interface (press of a button, movement of a slider, gesture, etc.) is recorded and a corresponding message reporting the interaction is sent from RUIMS 528 through RUIMS 522 to RUIMS 514. The reporting message includes details about the event, including the nameTag of the UI control, the label/text on the button, the screen the UI control is on, and the event captured (e.g., a pressed button).

The exemplary test targeting interface window 2240 of FIG. 26 presents a first option 2242 to display the alternative user interfaces to be tested randomly. If this option is selected then RUIMS 522 of the Server Computer 506 will cause display at various mobile computing devices running the tested application of one of the tested user interface windows (Current, Alternative A, or Alternative B) as selected in a random or other variable fashion. Alternatively, this may be handled by an application server by distributing different versions of the application (some including Alternative A, some including Alternative B) in accordance with the test parameters.

This exemplary test targeting interface window 2240 further presents a second option 2244 to cause display of the alternative user interfaces to be tested according to a fixed ratio. If this option is selected then the RUIMS 522/Server Computer 506 will cause display of one of the tested user interface windows (Current, Alternative A, or Alternative B) at various mobile computing devices running the tested application in accordance with the ratios or percentages assigned to each alternative via text entry fields 1844a, 1844b, 1844c. For example, this may involve the RUIMS 522/Server Computer 506 tracking the serving of each of the alternative user interface windows to mobile devices, and selecting a next alternative user interface to be served (e.g., by specifying and/or providing a playlist or portion thereof corresponding to the appropriate version) as a function of the alternative user interface windows previously served in response to execution of the application and/or request of the user interface window.

This exemplary test targeting interface window 2240 further presents a second option 2246 to cause display of the alternative user interfaces to be tested according to specified user data. If this option is selected then the RUIMS 522/Server Computer 506 will cause display of one of the tested user interface windows (Current, Alternative A, or Alternative B) at various mobile computing devices running the tested application in accordance with the user data provided elsewhere.

As shown in FIG. 27, the wizard next involves display of a test calibrating user interface window 2250. This window 2250 provides user input fields for specifying the timing of the test, as shown in window 2252. Further, this window 2250 provides for specification of the metric to be tracked for each version and/or test, as shown at window 2254. By way of example, the developer may select a metric to be measured from a drop-down list of metrics, which may be populated programmatically as a function of all of the controls and/or properties measurable in relation to those controls. By way of example, information for populating this menu may be hard coded into RUIMS 514 and/or RUIMS 522 and may be displayed in according to logic coded into RUIMS 522 as a function of the controls found in the user interface window to be tested. By way of example, for the exemplary user interface window 810 of FIG. 25, it may be desirable to measure the number of times, or time on screen as shown in FIG. 27, that the “PURCHASE INVITATION” button is clicked for each of the alternative user interfaces being tested.

One implementation for choosing a target for an A/B test is to leverage the ability to navigate through an application and for RUIMS 528 to communicate to RUIMS 514 details about what is happening in the application from the perspective of what was clicked on, and details about what UI controls are in the UI. The user initiates the selection of a target in the Web interface of RUIMS 514. As the user building the A/B test navigates the application's 526 UI, RUIMS 528 sends messages through RUIMS 522 to RUIMS 514 communicating what UI control the action was performed on and the action performed. Details about the UI control might contain the screen, nameTag or viewTag identifying the control, the text on the button, and the action performed such as a tap. This information is stored in RUIMS 522 and displayed in the Web interface of RUIMS 514. This enables a user building an A/B test to choose the target for the test by navigating through the site without needing to write any code or sift through previous analytic calls to identify the target combination of screen, UI control and action.

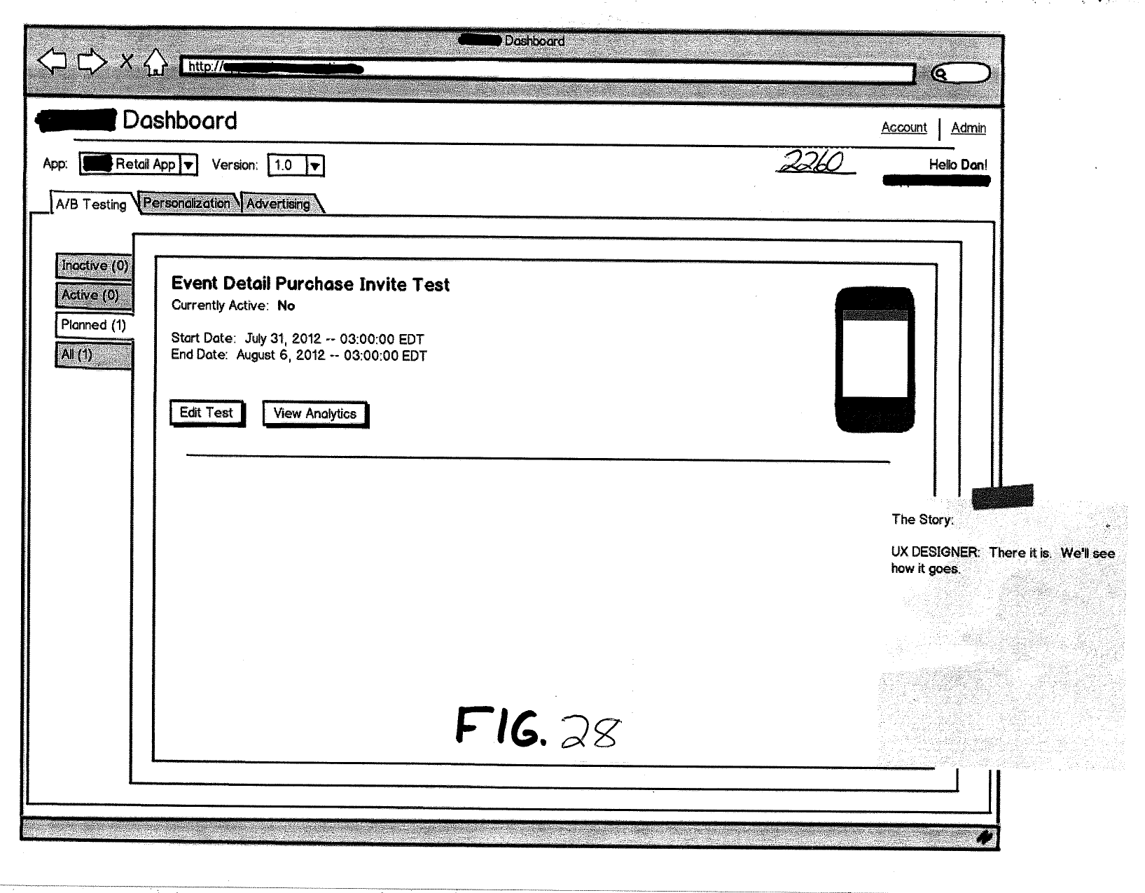

The test may then be implemented as planned, e.g., during a specific time frame. Preliminary test results may be viewable during the performance of the test, and the user interface may permit refinement of the test, as shown in test detail interface window 1860, as shown in FIG. 28.

After completion of the test, test result data may be displayed via test data interface window 2270, as shown in FIG. 29. By way of example, the test data interface window 2270 may display quantitative test results 2272 corresponding to the measured metric, for example alternative user interface. In this example, test data interface window 2270 shows that the “Purchase Invitation” button was clicked 10.1% of the time for the Current design of the user interface 810, 14.3% of the time for Alternative A, and 9.9% of the time for Alternative B. This data is indicative of a higher conversion rate for the user interface design of Alternative A, and thus indicates that Alternative A is the preferred user interface for improving and/or optimizing the rate at which the Purchase Invitation button is clicked, and thus that invitations are sold. Thus, this type of information is important to vendors, marketers, and others.

Optionally, the test data interface window 2270 may include user-selectable buttons to initiate display of graphical or other summaries 2274 of the test result data, as shown in FIG. 25.

Further, the wizard provides a user-selectable button for applying the results of the test to the production version of the application. In this example, test data interface window 2270 includes a button 2278 for causing application of a tested alternative as the production version, for use by all users. Accordingly, selection of the button 2278 in window 2270 causes display of an apply alternatives user interface window 2280 presenting the current and tested alternatives as user-selectable options, as best shown in FIG. 30. By selecting the highest-performing tested alternative (Alternative A) as the new current version of the user interface, all users of the application will subsequently receive and/or view only Alternative A of the tested user interface when they navigate to the corresponding screen in their mobile device application, and the old “Current” version, and “Alternative B” will be discontinued, since they are lower-performing versions of the user interface.

By applying the best-performing alternative to production, the RUIMS system effectively applies a 100% distribution or weighting to the highest-performing alternative, “Alternative A.” Accordingly, any users, mobile devices, or applications subsequently starting the associated application and/or requesting the user interface window for display will subsequently receive Alternative A to the exclusion of the other alternatives. In accordance with the present invention and the discussion above, this effect is provided by making a list of metadata changes, and publishing that list as a message. Such making of the list is performed and published by RUIMS 522 of Server Computer 506, such that all devices running the application receives that metadata, and thus will subsequently see those changes. As a result, Alternative A can be rolled out and provided to all users without having to recode or modify the application, or the republish the application to an application store or other centralized download site. Rather, the metadata is published to the individual users and is interpreted at runtime to provide the modified/updated version of the user interface corresponding to Alternative A, etc. This delivery model is advantageous to publishers of mobile device applications, in that it allows for changes to be reliably “pushed” to mobile device users, and does not rely on a pull-based model that would require each mobile device user to take action to re-download or update an application before seeing the updated interface, which would generally delay implementation and/or use of the updated interface across a group of mobile device users.

By way of illustration, use and operation of the RUIMS system may be described summarily as follows. Initially, a software application for displaying a user interface screen is created by compiling a RUIMS software development kit (SDK) along with source code to build the application. Subsequently, during execution of the application at a client computing device (i.e., at runtime), the SDK may be called. For example, after the software application executed to build a user interface screen for display via the client computing device, but before the user interface screen is displayed to the user, the SDK code runs and processes the view hierarchy of the screen. During such processing, the SDK assigns a viewID to each user interface control. If the developer had originally assigned a nameTag to the user interface control during initial creation of the course code, the user interface control may be assigned a viewID only. If the nameTag is empty the viewID may also be assigned to the nameTag. Thus, the nameTag will either by assigned by the developer or generated and be assigned from the viewID.

The Remote Server 506 (specifically RUIMS 522) communicates with the SDK through the use of the server's messaging server. The User Interface Management Device 502 (specifically RUIMS 514) sends a message to the Client Computing Device 508 (specifically the SDK/RUIMS 528) telling the SDK/RUIMS 528 to reverse engineer the user interface screen being currently displayed by the client computing device. The SDK/RUIMS 528 then makes a call to the Remote Server 506 (specifically RUIMS 522) to retrieve metadata for the types UI Controls in the software application. The metadata contains the property list and details about the properties to collect during the reverse engineering process. This permits adding, removing, or changing the details about what needs to be reverse engineered without the need to rebuild and re-integrate a new version of the SDK/RUIMS 528 into the software application. The SDK/RUIMS 528 then reverse engineers the screen using the metadata about the UI controls.

The SDK/RUIMS 528 then pushes the data collected to the Remote Server 506 (specifically RUIMS 522) for storage in Data Store 540. This data becomes the UIDD for the screen. For A/B testing the UIDD becomes the system of record for creating changes to the existing screen. Using the User Interface Management Device 502 (specifically RUIMS 514) a user can change properties (i.e. the text of a label) and this is stored in a change list for the variation of an A/B test. These changes are part of the playlist.

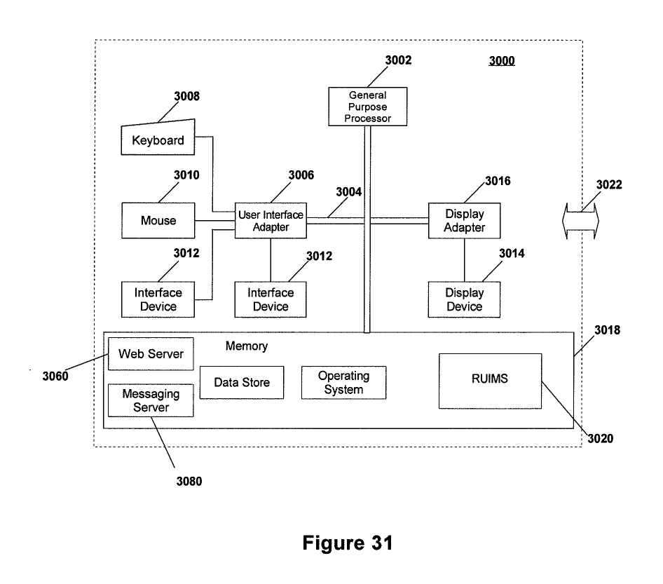

FIG. 31 is a schematic diagram showing an exemplary computer 3000 in accordance with an exemplary embodiment of the present invention. The computer 3000 may be a server computer, user interface management device, or client device shown in FIG. 5. Accordingly, the computer may include conventional client or server hardware and/or software. Further, the computer stores specially-configured computer software for carrying out methods in accordance with the present invention. Accordingly, the exemplary computer 3000 of FIG. 31 includes a general purpose microprocessor (CPU) 3102 and a bus 3104 employed to connect and enable communication between the microprocessor 3102 and the components of the computer 3000 in accordance with known techniques. The exemplary computer 3000 includes a user interface adapter 3006, which connects the microprocessor 3002 via the bus 3004 to one or more interface devices, such as a keyboard 3008, mouse 3010, and/or other interface devices 3012, which can be any user interface device, such as a touch sensitive screen, digitized entry pad, etc. The bus 3004 also connects a display device 3014, such as an LCD screen or monitor, to the microprocessor 3002 via a display adapter 3016. The bus 3004 also connects the microprocessor 3002 to memory 3018, which can include a hard drive, diskette drive, tape drive, RAM, ROM, etc.

The system 3000 may communicate with other computers or networks of computers, for example via a communications channel, network card or modem 3022. The system 3000 may be associated with such other computers in a local area network (LAN) or a wide area network (WAN), and may operate as a server in a client/server arrangement with another computer, etc. Such configurations, as well as the appropriate communications hardware and software, are known in the art.

The computer's software is specially configured in accordance with the present invention. Accordingly, as shown in FIG. 31, the system 3000 includes computer-readable, microprocessor-executable instructions stored in the memory for carrying out the methods described herein. Further, the memory stores certain data, shown logically in FIG. 31 for illustrative purposes, without regard to any particular embodiment in one or more hardware or software components. For example, FIG. 31 shows schematically storage in the memory 3018 of messaging server software 260, and a RUIMS component, e.g., 514, 518, 522, 528, 910, 916. Other data may be stored in the memory as discussed herein.

Additionally, computer readable media storing computer readable code for carrying out the method steps identified above is provided. The computer readable media stores code for carrying out subprocesses for carrying out the methods described above.

A computer program product recorded on a computer readable medium for carrying out the method steps identified above is provided. The computer program product comprises computer readable means for carrying out the methods described above.

Having thus described a few particular embodiments of the invention, various alterations, modifications, and improvements will readily occur to those skilled in the art. Such alterations, modifications and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

What is claimed is:

1. A method for providing runtime user interface management, the method comprising:
providing at a computing device a software application configured to display a user interface screen comprising a user interface control, the software application comprising code identifying the user interface control by a unique identification code, and further identifying original properties in association with the unique identification code for displaying the user interface control;
at a server, receiving from a client computing device a request for any playlist corresponding to the software application;
at the server, transmitting to the client computing device a corresponding playlist, the corresponding playlist identifying the unique identification code in association with updated properties different from the original properties;
during runtime of the software application at the computing device, displaying the user interface screen to include the user interface control as displayed in accordance with the updated properties contained in the playlist.

2. The method of claim 1, wherein said providing comprises developing a new software application, said developing comprising:
creating source code comprising a reference to a blank UIDD template stored at a server.

3. The method of claim 1, wherein said providing comprises developing a new software application, said developing comprising:
creating source code comprising a respective unique identification code in association with each of a plurality of user interface controls.

4. The method of claim 3, wherein creating source code comprising a respective unique identification code comprises providing the unique identification code as an alphanumeric string of characters.

5. The method of claim 1, wherein creating source code comprising a respective unique identification code comprises providing the unique identification code in a field of a User Interface Definition Document (UIDD).

6. The method of claim 1, wherein said providing comprises integrating source code with a software development kit comprising code for assigning at application runtime a respective unique identification codes to each of a plurality of user interface controls of the user interface screen displayable by the software application.

7. The method of claim 1, wherein said transmitting the playlist to the client computing device comprises transmitting the playlist in a format selected from the group consisting of an XML document, a JSON document, and an Apple plist.

8. The method of claim 1, wherein said transmitting the playlist to the client computing device comprises transmitting the playlist in a format selected from the group consisting of an XML document, a JSON document, and an Apple plist, the playlist comprising a plurality of playlist entries, each playlist entry identifying at least one unique identification code and associated updated properties.

9. The method of claim 1, wherein said displaying the user interface screen to include the user interface control as displayed in accordance with the updated properties comprises displaying the user interface control in accordance with the updated properties instead of the original properties.

10. The method of claim 1, wherein said displaying the user interface screen to include the user interface control as displayed in accordance with the updated properties comprises displaying the user interface control in accordance with the updated properties in addition to the original properties.

11. The method of claim 1, wherein said displaying the user interface screen to include the user interface control as displayed in accordance with the updated properties comprises displaying the user interface control in accordance with the original properties to the extent that they do not conflict with the updated properties, and in accordance with the updated properties to the extent that they do conflict with the updated properties.

12. The method of claim 1, further comprising:
during runtime of the software application, navigating within the software application's user interface to the user interface screen to cause display via the client computing device of the user interface screen,
wherein said assigning and said creating are performed at said client computing device during runtime of said software application and immediately preceding display of the user interface screen via the client computing device.

13. A method for providing runtime user interface management, the method comprising:
providing a software development kit for integration with source code to build a software application for displaying a user interface screen comprising at least one user interface control, the code identifying original properties for displaying each user interface control, the software development kit comprising code for assigning a unique identification code to each user interface control of the source code during runtime of a software application;
receiving from a client computing device during runtime of the software application comprising the software development kit, a list identifying each user interface control of the user interface screen being presently displayed by the client computing device, the list identifying a corresponding unique identification code and associated original properties for each of user interface control;
transmitting the list via a communications network for display via a user interface management device;
receiving from the user interface management device a playlist identifying at least one change to the list, the playlist identifying at least one unique identification code in association with corresponding properties;
transmitting the playlist to the client computing device;
during runtime of the software application at the client computing device, applying the at least one change reflected by the playlist to cause display of the user interface screen in accordance with the at least one change.

14. The method of claim 13, receiving from a client computing device a list identifying each user interface control of the user interface screen being presently displayed by the client computing device comprises received a list that does not identify any user interface controls.

15. The method of claim 13, wherein receiving from the user interface management device input identifying at least one change to the list comprises receiving input reflecting addition of a new user interface control, and associated updated properties for the new user interface control.

16. The method of claim 13, wherein receiving from the user interface management device input identifying at least one change to the list comprises receiving input reflecting change of an original property to an updated property for a user interface control.

17. The method of claim 13, further comprising storing the playlist at a server capable of communication via a communications network.

18. The method of claim 17, further comprising receiving at the server, from a client computing device, a request attempting to retrieve a playlist corresponding to the software application.

19. The method of claim 18, further comprising:
identifying a distribution rule for selectively distributing the playlist; and
in response to the request, selectively transmitting the playlist to the client computing device only in compliance with the distribution rule.

20. The method of claim 19, wherein said selectively transmitting comprises selectively transmitting the playlist in accordance with a predefined distribution ratio.

21. The method of claim 19, wherein said selectively transmitting comprises selectively transmitting the playlist as a function of a device type of the computing device.

22. The method of claim 19, wherein said selectively transmitting comprises selectively transmitting the playlist as a function of a geographic location of the computing device.

23. The method of claim 18, further comprising:
at the client computing device, identifying a distribution rule for the playlist, wherein said applying the at least one change reflected by the playlist comprises selectively applying at least one change reflected by the playlist only in accordance with the distribution rule.

24. The method of claim 23, wherein the playlist comprises a plurality of playlist entries, and the distribution rule provides for selectively applying a subset of said plurality of playlist entries.

25. The method of claim 19, further comprising:
monitoring use of the user interface by a first plurality of computing devices;
monitoring use of the user interface by a second plurality of computing device;
displaying via the user interface management device information comparing use of the user interface by the first and second pluralities of computing devices.

26. The method of claim 19, further comprising:
monitoring use of a first version of the user interface by a first plurality of computing devices having received the playlist;
monitoring use of a second version of the user interface by a second plurality of computing device having not received the playlist;
displaying via the user interface management device information comparing use of each version of the user interface by the first and second pluralities of computing devices.

27. The method of claim 26, further comprising:
receiving, from the user interface management device, input modifying said at least one distribution rule for selectively distributing the playlist.

28. A system for providing runtime user interface management, the system comprising:
a server computer storing at least one version of a User Interface Definition Document (UIDD);
a client computing device operably connected to a communications network for communication with the server computer, the client computing device comprising a software application for displaying a user interface, the software application being configured to display the user interface as a function of information contained in the UIDD; and
a user interface management computing device operably connected to a communications network for communication with the server computer, the user interface management computing device comprising an interface for receiving inputted changes to the user interface of the software application, and responsively revising the UIDD stored at the server computer, the revised UIDD reflecting corresponding changes, and sending a message causing the client computing device to display a revised user interface as a function of information contained in the revised UIDD.

29. The system of claim 28, wherein multiple UIDDs are distributed concurrently during a multivariate testing period, and wherein the user interface management computing device is operable to end the testing period and subsequently cause distribution of a single UIDD as a function of comparative results associated with the UIDDs during the testing period.

30. A method for providing runtime user interface management, the method comprising:
providing a software development kit for integration with source code to build a software application for displaying a user interface screen comprising at least one user interface control, the source code identifying original properties for displaying each user interface control, the software development kit comprising code for:
assigning, during runtime of the software application, a unique identification code to each user interface control identified in a view hierarchy corresponding to the user interface screen; and
creating a document identifying each assigned unique identification code and associated original properties for each user interface control of the user interface screen;
during runtime of the software application at a client computing device, receiving the document at a server;
transmitting the document from the server to a user interface management device;
displaying, at the user interface management device, each unique identification code and its associated original properties;
receiving, at the user interface management device, input reflecting at least one change to the user interface screen;
creating, at the user interface management device, a playlist identifying at least one change to the user interface screen, the playlist identifying at least one unique identification code in association with corresponding properties;
receiving at a server, from the user interface management device, the playlist;
storing the playlist at the server;
transmitting the playlist from the server to the client computing device;
at the client computing device, during runtime of the software application, applying the at least one change identified in the playlist to each user interface control associated with each associated unique identification code; and
at the client computing device, displaying the user interface screen to reflect the at least one change identified in the playlist.

31. The method of claim 30, further comprising:
in response to receipt of a request from another client computing device during its runtime of the software application, transmitting the playlist from the server to the another client computing device;
at the another client computing device, during its runtime of the software application, applying the at least one change identified in the playlist to each user interface control associated with each associated unique identification code; and
at the another client computing device, displaying the user interface screen to reflect the at least one change identified in the playlist.

32. The method of claim 30, wherein the playlist identifies a plurality of changes, the client computing device applying a first subset of said plurality of changes in accordance with a distribution rule for applying said plurality of changes, said method further comprising:
in response to receipt of a request from another client computing device during its runtime of the software application, transmitting the playlist from the server to the another client computing device;
at the another client computing device, during its runtime of the software application, applying a second subset of said plurality of changes different from said first subset in accordance with a distribution rule for applying said plurality of changes; and
at the another client computing device, displaying the user interface screen to reflect the second subset of changes.

33. The method of claim 30, further comprising:
during runtime of the software application, navigating within the software application's user interface to the user interface screen to cause display via the client computing device of the user interface screen,
wherein said assigning and said creating are performed at said client computing device during runtime of said software application and immediately preceding display of the user interface screen via the client computing device.

34. A server for facilitating runtime user interface management for a software application, the server comprising:
a microprocessor;
a memory; and
microprocessor-executable instructions stored in the memory and executable by the microprocessor to:
provide a software development kit for integration with source code to build a software application for displaying a user interface screen comprising at least one user interface control, the source code identifying original properties for displaying each user interface control, the software development kit comprising code for, during runtime of the software application at a client computing device:
assigning a unique identification code to each user interface control identified a view hierarchy corresponding to the user interface screen;
creating a document identifying each assigned unique identification code and associated original properties for each user interface control of the view hierarchy;
transmitting the document to a server;
requesting from the server any playlist corresponding to the software application; and
before display of the user interface screen, applying any updated properties from any received playlist to the view hierarchy to cause display of the user interface screen in accordance with the updates provided in any received playlist.

35. A server for providing runtime user interface management for a software application, the server comprising:
a microprocessor;
a memory; and
instructions stored in the memory for causing the server, as controlled by the microprocessor, to:
receive from a client computing device during runtime of a software application for displaying a user interface screen comprising at least one user interface control, a document identifying a unique identification code and associated original properties for each user interface control associated with a view hierarchy corresponding to the user interface screen;
transmit the document for display at a user interface management device;
receive from the user interface management device a playlist identifying at least one change to the view hierarchy, the playlist identifying at least one unique identification code and associated properties for a corresponding user interface control displayable as part of the user interface screen; and
storing the playlist in the memory of the server.

36. The server of claim 35, further comprising:
instructions stored in the memory for causing the server, as controlled by the microprocessor, to:
receive from a client computing device a request for any playlist associated with the software application resident at the client computing device;
search the memory for any playlist corresponding to the software application to identify an applicable playlist; and
transmit the applicable playlist to the client computing device.

37. The server of claim 36, further comprising:
instructions stored in the memory for causing the server, as controlled by the microprocessor, to:
determine a distribution rule for selectively distributing any playlist corresponding to the software application;
wherein said instructions for transmitting the applicable playlist to the client computing device are configured to selectively transmit any playlist in compliance with the distribution rule.

38. The server of claim 37, wherein said instructions for transmitting the applicable playlist to the client computing device are configured to selectively transmit a playlist in accordance with a predefined distribution ratio.

39. The server of claim 37, wherein said instructions for transmitting the applicable playlist to the client computing device are configured to selectively transmit each of a plurality of playlists in accordance with a predefined distribution ratio.

40. The server of claim 37, wherein said instructions for transmitting the applicable playlist to the client computing device are configured to selectively transmit a playlist as a function of a device type of the client computing device.

41. The server of claim 37, wherein said instructions for transmitting the applicable playlist to the client computing device are configured to selectively transmit a playlist as a function of a geographic location of the client computing device.

42. The server of claim 37, further comprising:
instructions stored in the memory for causing the server, as controlled by the microprocessor, to:
monitor use of the user interface by a first plurality of computing devices having received the playlist;
monitor use of the user interface by a second plurality of computing device having not received the playlist;
transmit for display via the user interface management device information comparing use of the user interface by the first and second pluralities of computing devices.

43. The server of claim 36, further comprising:
instructions stored in the memory for causing the server, as controlled by the microprocessor, to:
determine a distribution rule for selectively distributing any playlist corresponding to the software application; and
transmit the distribution rule to the client computing device;
wherein the distribution rule is applied by the client computing device to selectively apply any transmitted playlist in compliance with the distribution rule.

44. The server of claim 36, further comprising:
instructions stored in the memory for causing the server, as controlled by the microprocessor, to:
receive, from the user interface management device, input modifying said at least one distribution rule for selectively distributing the playlist; and
store the distribution rule in the memory of the server.

45. A client computing device for providing runtime user interface management, the client computing device comprising:
a microprocessor;
a memory; and
instructions stored in the memory for causing the client computing device, as controlled by the microprocessor, to:
display a user interface screen comprising at least one user interface control, the user interface screen being displayable in accordance with original properties contained in a software application;
create and store in the memory a view hierarchy for displaying each user interface control of the user interface screen, the view hierarchy identifying each user interface control and its associated original properties;
assign in automated fashion a unique identification code to each user interface control identified in the view hierarchy;
create a document identifying each assigned unique identification code and its associated original properties for each user interface control;
transmit the document via a communications network;
request and receive from a server any playlist corresponding to the software application; and
during runtime of the software application and before display of the user interface screen, apply to the view hierarchy any updates from any received playlist; and
during runtime of the software application, cause display the user interface controls and user interface screen in accordance with the view hierarchy as updated during runtime by any changes contained in any received playlist.

46. A user interface management device for providing runtime user interface management, the user interface management device comprising:
a display device;
a microprocessor;
a memory; and
instructions stored in the memory for causing the user interface management device, as controlled by the microprocessor, to:
receive a document identifying a unique identification code and its associated original properties for each user interface control of a view hierarchy created during runtime of a software application for displaying a user interface screen comprising at least one user interface control;
display via the display device a list of each unique identification code and its associated original properties;
receive input providing changes to the list;
create a playlist document reflecting changes to the list; and
transmit the document via a communications network.

47. The user interface management device of claim 46, wherein said input comprises an updated property reflecting a revision to an original property associated with the unique identification code, and wherein the instructions to create the playlist document comprises creation of the playlist document to identify the updated property in association with the corresponding unique identification code.

48. The user interface management device of claim 47, wherein said input comprises addition of a new user interface control and associated properties, and wherein the instructions to create the playlist document comprises creation of the playlist document to identify the new user interface control and its associated properties in association with a corresponding identification code.

49. The user interface management device of claim 47, wherein said input comprises removal of a user interface control and its associated properties, and wherein the instructions to create the playlist document comprises creation of the playlist document to remove the user interface control and its associated properties in association with the corresponding unique identification code.
